(19) United States
(12) Patent Application Publication
(10) Pub. No.: US 2024/0171087 A1
(43) Pub. Date: May 23, 2024

(54) HEATING DEVICE AND OUTPUT CONTROL METHOD FOR HEATING DEVICE

(71) Applicant: Samsung Electronics Co., Ltd., Suwon-si, Gyeonggi-do (KR)

(72) Inventors: Myoungjin HAM, Suwon-si (KR); Jiwoong CHOI, Suwon-si (KR); Heejoon KANG, Suwon-si (KR); Byunghwan KO, Suwon-si (KR); Younghoon WOO, Suwon-si (KR)

(21) Appl. No.: 18/420,644

(22) Filed: Jan. 23, 2024

Related U.S. Application Data
(63) Continuation of application No. PCT/KR2022/008275, filed on Jun. 13, 2022.

(30) Foreign Application Priority Data
Jul. 23, 2021 (KR) 10-2021-0097189

(51) Int. Cl. H02M 7/217; F24C 7/08; H05B 6/06; H05B 6/12

(52) U.S. Cl. CPC H02M 7/2176; F24C 7/087; H05B 6/062; H05B 6/1236; H05B 2213/07

(57) ABSTRACT

A heating device including a high-power heating area is disclosed. In detail, the heating device includes a switch and a controller, wherein the switch is configured to connect an alternating current (AC) power source to a rectifying portion in order to provide AC power of different power phases to a plurality of rectifiers for a high-power heating area when high power is provided through the high-power heating area of the heating device and in order to provide AC power of only one AC power phase from among the different power phases to the plurality of rectifiers for the high-power heating area when low power is provided through the high-power heating area, and the controller is configured to control a switching operation of the switch according to a power level of the heating device.

### CROSS-REFERENCE TO RELATED APPLICATIONS

This application is a Bypass Continuation of International Application No. PCT/KR2022/008275, filed Jun. 13, 2022, which claims priority to Korean Patent Application No. 10-2021-0097189, filed Jul. 23, 2021, the disclosures of which are herein incorporated by reference in their entirety.

### BACKGROUND

### 1. Field

The disclosure relates to a heating device and a method of controlling power of the heating device based on a heating element included in the heating device.

### 2. Description of Related Art

A heating device is a device for cooking a cooking object such as food by heating the cooking object. The heating device may cook the cooking object by heating the cooking object by using various methods. An induction heating (IH)-based heating device supplies a current to a heating coil to generate a magnetic field. When the magnetic field passes through a bottom surface of a conductive cooking vessel placed in a heating area of the heating device generating the magnetic field, an eddy current is induced according to Faraday's law. Thus, the conductive cooking vessel is heated by Joule's heat generated based on the surface resistance, and a cooking object in the conductive cooking vessel is cooked. Like this, the IH-based heating device uses the principle of induction heating that converts electrical energy into thermal energy.

The IH-based heating device may include a high-power heating area and a low-power heating area based on heating coils. The high-power heating area may include a plurality of heating coils, and the low-power heating area may include one heating coil.

In order to use the high-power heating area, high electrical energy has to be supplied thereto. Thus, in a previous heating device, a plurality of switch components connecting a power source to the plurality of heating coils are used, which may cause an increase in product costs.

### SUMMARY

According to an embodiment of the disclosure, there is provided a heating device and a power control method of the heating device, according to which high quality power performance may be provided while reducing the number of switch components.

A heating device according to an embodiment of the disclosure includes: a high-power burner including a first heating coil, a second heating coil, and a third heating coil; a first alternating current (AC) power source configured to supply first AC power; a second AC power source configured to supply second AC power having a different phase from the first AC power; a rectifying portion including a first rectifier and a second rectifier, wherein the first rectifier is configured to rectify the first AC power supplied from the first AC power source, and the second rectifier is configured to rectify AC power supplied from the first AC power source or the second AC power source; a switch configured to selectively connect the first AC power source and the second AC power source to the second rectifier according to a power level of the high-power burner; a coil driving circuit including a first coil driving circuit and a second coil driving circuit, wherein the first coil driving circuit is configured to drive the first heating coil when rectified direct current (DC) power is supplied to the first coil driving circuit from the first rectifier, and the second coil driving circuit is configured to drive at least one of the second heating coil and the third heating coil when rectified DC power is supplied to the second coil driving circuit from the second rectifier; and a controller configured to control an operation of the switch and an operation of the coil driving circuit according to the power level of the high-power burner.

A heating device according to an embodiment of the disclosure includes: a power source configured to supply power having different power phases; a first heating area configured to provide high power or low power; a second heating area configured to provide low power; a first rectifying portion including a plurality of rectifiers configured to rectify alternating current (AC) power supplied from the power source and configured to distribute, based on the plurality of rectifiers, a current supplied to the first heating area; a second rectifying portion configured to rectify AC power of one power phase from among different power phases supplied from the power source and supply, to the second heating area, the rectified power; a switch configured to selectively connect the power source to the first rectifying portion such that the AC power of the one power phase from among the different power phases supplied from the power source is supplied to the first rectifying portion according to a power level of the heating device; and a controller configured to control an operation of the switch according to the power level of the heating device.

A power control method of a heating device operating based on different power phases according to an embodiment of the disclosure includes: receiving a power level setting command of the heating device; while performing a control operation to selectively supply power of one power phase from among the different power phases to a first rectifying portion of the heating device according to the power level setting command of the heating device, constantly supplying power of another power phase from among the different power phases to the first rectifying portion; distributing a current by using a plurality of rectifiers included in the first rectifying portion; and supplying the current distributed by the first rectifying portion to a first heating area, wherein the first heating area provides high power or low power.

According to an embodiment of the disclosure, a heating device may provide high power that is higher than a power capacity permitted for one power phase or/and low power equal to or lower than the power capacity permitted for one power phase even in a region having a limited power capacity.

According to an embodiment of the disclosure, a heating device may decrease the number of switch components used to provide a power supply during a high-power operation or a low-power operation of a high-power heating area and may thus increase the price competitiveness.

According to an embodiment of the disclosure, a heating device may place a switch component at a front end of a rectifying portion and may thus reduce a danger caused by fusion defects of the switch component.

According to an embodiment of the disclosure, a heating device may increase the number of heating coils included in a high-power heating area and may thus increase the maximum power provided through the high-power heating area and use cooking vessels of various sizes.

According to an embodiment of the disclosure, a heating device may increase the number of rectifiers connected to a plurality of heating coils included in a high-power heating area so as to distribute the heating temperature of the rectifiers and may thus improve power holding time with respect to the high-power heating area of the heating device.

According to an embodiment of the disclosure, a heating device may drive one or more heating coils from among a plurality of heating coils included in a high-power heating area as one power unit or one coil driving circuit and may thus improve the price competitiveness.

According to an embodiment of the disclosure, a heating device may simultaneously use a low-power heating area during a high-power operation or a low-power operation of a high-power heating area.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram for describing a heating device according to an embodiment of the disclosure.

FIG. 2 is a block diagram for describing a function of a heating device according to an embodiment of the disclosure.

FIG. 3 is a flowchart for describing a power control method of a heating device, according to an embodiment of the disclosure.

FIG. 4 is a flowchart for describing a switching operation according to a power level of a heating device in a power control method of the heating device, according to an embodiment of the disclosure.

FIG. 5 is a functional block diagram for describing a heating device according to an embodiment of the disclosure.

FIG. 6 is an example waveform diagram of a zero voltage detected during a high-power operation by a heating device through a first heating area.

FIG. 7 is an example waveform diagram of a zero voltage detected during a low-power operation by a heating device through a first heating area.

FIG. 8 is a flowchart for describing a power control method of a heating device, according to an embodiment of the disclosure.

FIG. 9 is a flowchart for describing a power control method of a heating device, according to an embodiment of the disclosure.

FIG. 10 is a flowchart for describing a power control method of a heating device, according to an embodiment of the disclosure.

FIG. 11 is a block diagram for describing a function of a heating device according to an embodiment of the disclosure.

FIG. 12 is a block diagram for describing a function of a heating device according to an embodiment of the disclosure.

FIG. 13 is a block diagram for describing a function of a heating device according to an embodiment of the disclosure.

FIG. 14 is a block diagram for describing a function of a heating device according to an embodiment of the disclosure.

FIG. 15 is a block diagram for describing a function of a heating device according to an embodiment of the disclosure.

FIG. 16 is an example detailed circuit diagram of a first heating coil to a third heating coil included in a heating device and a first coil driving circuit and a second coil driving circuit connected to the first to third heating coils, according to an embodiment of the disclosure.

### DETAILED DESCRIPTION

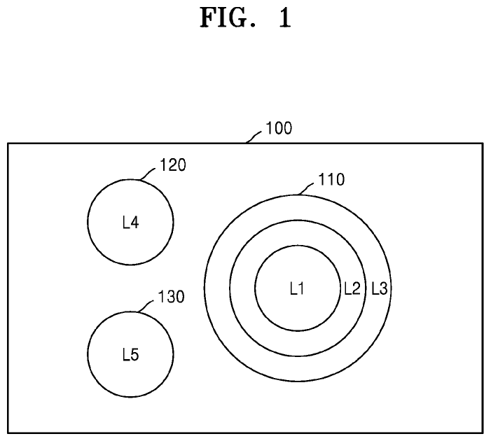

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The terms used in the disclosure will be briefly described, and then an embodiment of the disclosure will be described in detail.

The terms used in the disclosure are general terms as possible that have been widely used nowadays in consideration of the functions in the disclosure, which, however, may be changed according to an intention of a technician in the art, a precedent, the advent of new technologies, or the like. Also, particular cases may include terms arbitrary selected by an applicant, and in this case, the meaning of the terms will be described in detail in the corresponding description. Therefore, the terms used in the disclosure should be defined based on the meanings of the terms and the content throughout the disclosure, rather than simply based on the titles of the terms.

Throughout the disclosure, when a part “includes” or “comprises” an element, the part may further include other elements, not excluding the other elements, unless there is a particular description contrary thereto. Also, the terms, such as “unit” or “module,” used in the disclosure, should be understood as a unit that processes at least one function or operation and that may be embodied in a hardware manner, a software manner, or a combination of the hardware manner and the software manner.

Hereinafter, an embodiment of the disclosure will be described in detail with reference to the accompanying drawings, so that the embodiment of the disclosure may be easily implemented by one of ordinary skill in the art. However, an embodiment of the disclosure may have different forms and should not be construed as being limited to the embodiment of the disclosure described herein. Also, in the drawings, parts not related to descriptions are omitted for the clear description of an embodiment of the disclosure, and throughout the specification, like reference numerals are used for like elements.

FIG. 1 is a diagram for describing a heating device according to an embodiment of the disclosure.

A heating device 100 according to an embodiment of the disclosure may be an electronic device or a cooking device configured to cook a cooking object such as food by heating the cooking object. Power of the heating device 100 may be a power supply provided by the heating device 100 in order to heat the cooking object. The power of the heating device 100 may be represented in units of watt (W).

The heating device 100 according to an embodiment of the disclosure may include a first heating area 110, a second heating area 120, and a third heating area 130.

The first heating area 110 according to an embodiment of the disclosure may be a high-power heating area of the heating device 100. The high-power heating area may be an area capable of providing a power value that is higher than a predetermined power value. The high-power heating area may be an area capable of inducing an electromotive force having a predetermined intensity or higher. The high-power heating area may be represented as a high-power burner (HB). The high-power heating area may be a cooking area operating in high power (or the maximum power) in order to cook the cooking object. Thus, the heating device 100 may provide high power or low power by using the first heating area 110. To provide low power by using the first heating area 110 may be to provide a predetermined power value or lower. To provide low power by using the first heating area 110 may be to induce an electromotive force of a predetermined intensity or lower. To provide high power by using the first heating area 110 may denote to perform, via the heating device 100, a high-power operation by using the first heating area 110. To provide low power by using the first heating area 110 may denote to perform, via the heating device 100, a low-power operation by using the first heating area 110.

The second heating area 120 and the third heating area 130 according to an embodiment of the disclosure may be low-power heating areas of the heating device 100. The low-power heating area may be an area capable of providing a predetermined power value or lower. The low-power heating area may be an area for inducing an electromotive force having a predetermined intensity or lower. The low-power heating area may be represented as a low-power burner (LB). The low-power heating area may be a cooking area operating in low power to cook the cooking object. Thus, the heating device 100 may perform a low-power operation by using the second heating area 120 and the third heating area 130.

A high-power level of the heating device 100 according to an embodiment of the disclosure may denote providing a power value that is higher than a predetermined power value through the first heating area 110. A high-power level of the heating device 100 according to an embodiment of the disclosure may denote inducing an electromotive force having a predetermined intensity or higher through the first heating area 110. The high-power level according to an embodiment of the disclosure may be referred to as high power, a high-power operation, or a high-power operation mode.

For example, when the maximum power (total power) value that may be provided by the heating device 100 is 7.4 kW, the heating device 100 may provide, in the high-power level, by using the first heating area 110, a power value that is higher than 3.7 kW which is a predetermined power value. The maximum power value may be the total power value. For example, the heating device 100 may provide, in the high-power level, by using the first heating area 110, power of 5.5 kW. The heating device 100 according to an embodiment of the disclosure may set the high-power level as one stage, but is not limited thereto. For example, the heating device 100 may set the high-power level as a plurality of stages. When the high-power level is set as the plurality of stages, power values provided based on the plurality of stages may or may not have equidistant intervals. The heating device 100 according to an embodiment of the disclosure may predetermine and store power values corresponding to the plurality of stages.

A low-power level of the heating device 100 according to an embodiment of the disclosure may denote providing a small power value that is equal to or lower than a predetermined power value by using the first heating area 110. The low-power level according to an embodiment of the disclosure may be referred to as low power or a low-power operation.

For example, when the maximum power value that may be provided by the heating device 100 is 7.4 kW, the heating device 100 may provide, in the low-power level, by using the first heating device 100, a power value that is equal to or lower than 3.7 kW which is a predetermined power value. The heating device 100 according to an embodiment of the disclosure may set the low-power level as 15 stages, but is not limited thereto. For example, the heating device 100 may set the low-power level as 10 stages. When the low-power level is set as 15 stages, power values provided based on the 15 stages may or may not have equidistant intervals. The heating device 100 according to an embodiment of the disclosure may predetermine and store the power values corresponding to the 15 stages.

The heating device 100 according to an embodiment of the disclosure may provide low power by using each of the first heating area 110, the second heating area 120, and the third heating area 130. For example, each of the first heating area 110, the second heating area 120, and the third heating area 130 may perform a low-power operation. For example, when the maximum power value that may be provided by the heating device 100 is 7.4 kW, the heating device 100, in a low-power operation, may provide a power value of 3.7 kW or lower by using the first heating area 110 and may provide the maximum power value of 3.7 kW or lower by using the second heating area 120 and the third heating area 130.

The heating device 100 according to an embodiment of the disclosure may provide the power value of 3.7 kW or lower by dividing the power value of 3.7 kW or lower into the second heating area 120 and the third heating area 130. The heating device 100 according to an embodiment of the disclosure may provide different power values from each other by using the second heating area 120 and the third heating area 130. For example, the heating device 100 may provide the maximum power value of 1.4 kW by using the second heating area 120 and the maximum power value of 2.3 kW by using the third heating area 130. The heating device 100 according to an embodiment of the disclosure may provide the same power value as each other by using the second heating area 120 and the third heating area 130. According to the heating device 100 according to an embodiment of the disclosure, the maximum power value that may be provided by using the second heating area 120 and the third heating area 130 may be a power value corresponding to ½ or ⅓ of the maximum power value which may be provided by using the first heating area 110.

When the heating device 100 according to an embodiment of the disclosure provides high power by using the first heating area 110, the heating device 100 may provide low power by using each of the second heating area 120 and the third heating area 130. For example, when the heating device 100 provides high power of 5.5 kW by using the first heating area 110, the heating device 100 may provide the maximum power value of 1.2 kW by using the second heating area 120 and the third heating area 130. The second heating area 120 and the third heating area 130 may provide the power value of 1.2 kW divided.

Accordingly, when the heating device 100 according to an embodiment of the disclosure performs a high-power operation (or a high-power operation mode) or a low-power operation (or a low-power operation mode) by using the first heating area 110, the heating device 100 may perform the low-power operation (or the low-power operation mode) by using the second heating area 120 and the third heating area 130 together.

For example, when the heating device 100 is capable of providing the maximum power value of 7.4 kW based on the first heating area 110, the second heating area 120, and the third heating area 130, and when a power level of the first heating area 110 is set as a high-power level, the first heating area 110 may provide a power value of 5.5 kW, the second heating area 120 may provide the maximum power value of 0.6 kW, and the third heating area 130 may provide the maximum power value of 0.6 kW.

Also, when the heating device 100 is capable of providing the maximum power value of 7.4 kW based on the first heating area 110, the second heating area 120, and the third heating area 130, and when a power level of the first heating area 110 is set as a low-power level, the first heating area 110 may provide the maximum power value of 3.7 kW, the second heating area 120 may provide the maximum power value of 1.4 kW, and the third heating area 130 may provide the maximum power value of 2.3 kW.

The first heating area 110 according to an embodiment of the disclosure may include three heating elements L1, L2, and L3. The second heating area 120 according to an embodiment of the disclosure may include one heating element L4. The third heating area 130 according to an embodiment of the disclosure may include one heating element L5.

According to an embodiment of the disclosure, the heating elements L1 to L5 may be formed as heating coils or heating inductors. The heating elements L1 to L5 may be formed as other heating elements corresponding to heating coils.

According to an embodiment of the disclosure, the heating device 100 may generate a magnetic field by supplying a current to the heating elements L1 to L5 included in the first heating area 110, the second heating area 120, and the third heating area 130.

According to an embodiment of the disclosure, the heating device 100 may be implemented to include only two heating elements L1 and L2 from among the three heating elements L1 to L3 included in the first heating area 110. Also, the heating device 100 may be implemented to further include another heating element in addition to the three heating elements L1 to L3 included in the first heating area 110.

According to an embodiment of the disclosure, the first heating area 110 may include a plurality of sub-heating areas based on the three heating elements L1, L2, and L3. For example, the plurality of sub-heating areas may include a first sub-heating area based on the heating element L1 and a second sub-heating area based on the heating element L2 and the heating element L3. Alternatively, the plurality of sub-heating areas may include a first sub-heating area based on the heating element L1, a second sub-heating area based on the heating element L2, and a third sub-heating area based on the heating element L3. According to an embodiment of the disclosure, the sub-heating areas of the first heating area 110 are not limited thereto.

According to an embodiment of the disclosure, the plurality of sub-heating areas included in the first heating area 110 may operate as individually-driven power units. For example, when the first heating area 110 includes the first sub-heating area based on the heating element L1 and the second sub-heating area based on the heating elements L2 and L3, the heating device 100 may drive only the first sub-heating area and may not drive the second sub-heating area. Also, after the heating device 100 drives both of the first sub-heating area and the second sub-heating area, the heating device 100 may drive only the first sub-heating area. The driving of the sub-heating areas is not limited to the description above. When the second sub-heating area based on the heating elements L2 and L3 is driven as one individual power unit or through one driving circuit, the heating device 100 may have improved power competitiveness.

According to an embodiment of the disclosure, the heating device 100 may be implemented to further include another heating element in addition to the heating element L4 included in the second heating area 120. The heating device 100 may be implemented to further include another heating element in addition to the heating element L5 included in the third heating area 130.

According to an embodiment of the disclosure, a vessel placed in the first heating area 110, the second heating area 120, or the third heating area 130 may be a conductive cooking vessel. For example, the conductive cooking vessel may be a cooking vessel configured to generate Joule's heat based on a magnetic field generated by the first heating area 110, the second heating area 120, or the third heating area 130.

According to an embodiment of the disclosure, the form of the heating device 100 may vary. For example, the heating device 100 may include only the first heating area 110. When the heating device 100 includes only the first heating area 110, the heating device 100 may perform a high-power operation or a low-power operation by using the first heating area 110.

According to an embodiment of the disclosure, the heating device 100 may include only the first heating area 110 and the second heating area 120. When the heating device 100 includes the first heating area 110 and the second heating area 120, the heating device 100 may perform a low-power operation by using the second heating area 120, when the heating device 100 performs a high power operation or the low-power operation by using the first heating area 110.

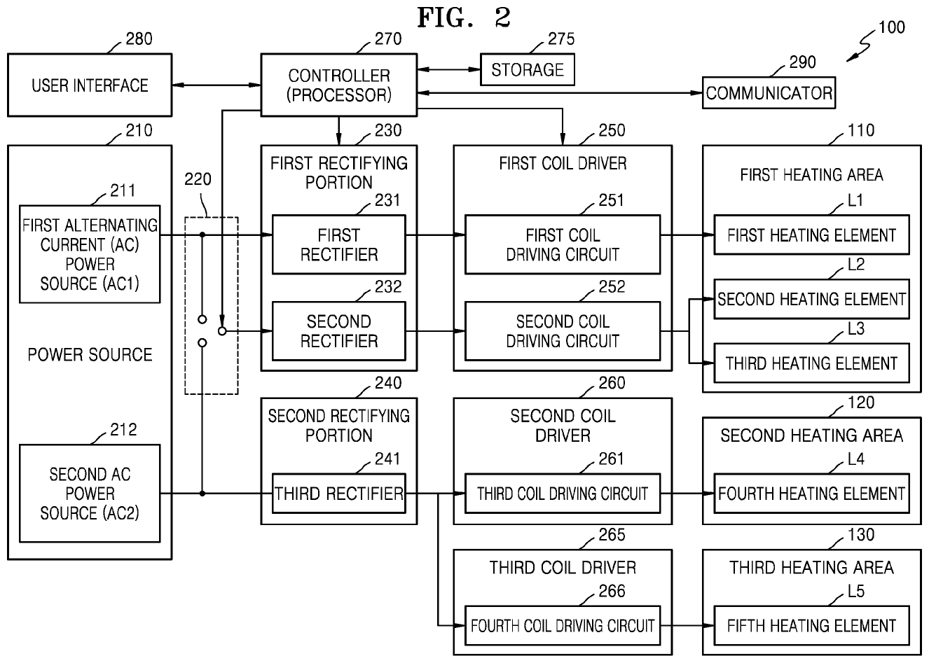

FIG. 2 is a block diagram for describing a function of the heating device 100 according to an embodiment of the disclosure.

As illustrated in FIG. 2, the heating device 100 according to an embodiment of the disclosure may include a power source 210, a switch 220, a first rectifying portion 230, a second rectifying portion 240, a first coil driver 250, a second coil driver 260, a third coil driver 265, the first heating area 110, the second heating area 120, the third heating area 130, a controller 270, a storage 275, a user interface 280, and a communicator 290.

The power source 210 may provide alternating current (AC) power supplies having different phases. The power source 210 may include a first AC power source 211 and a second AC power source 212. The first AC power source 211 and the second AC power source 212 may provide AC power supplies having different phases from each other. For example, the first AC power source 211 and the second AC power source 212 may be configured to provide AC power supplies having a phase difference of 120 degrees from each other. For example, each of the first AC power source 211 and the second AC power source 212 may be configured to provide an AC power supply of 3.7 kW having a phase difference of 120 degrees based on the maximum current of 16 A and a voltage of 230V.

According to an embodiment of the disclosure, when a power level of the heating device 100 is set as a high-power level, for example, the first AC power source 211 may provide an AC power supply of 3 kW (P=IV, P: power, I: current, and V: voltage) based on a current of 13 A and a voltage of 230V, and the second AC power source 212 may provide an AC power supply of 3.7 kW based on a current of 16 A and a voltage of 230V. Accordingly, the first heating area 110 may provide high power of 5.5 kW (3 kW+2.5 kW) at most, and the second heating area 120 and the third heating area 130 may provide low power of 1.2 kW at most.

The high power that may be provided by using the first heating area 110 may vary, for example, in a range of 3.6 to 6.0 kW. When the maximum power value (for example, 5.5 kW) which may be provided by using the first heating area 110 is changed, each power value that is provided by the first heating area 110, the second heating area 120, or the third heating area 130, corresponding to information of each power level of the first heating area 110, the second heating area 120, or the third heating area 130, may be reset. The maximum power value (for example, 5.5 kW) that may be provided by using the first heating area 110 may be set in a stage of designing a product or may be changed according to a user command received through the user interface 280 or the communicator 290.

According to an embodiment of the disclosure, when the power level of the heating device 100 is set as a low-power level, for example, the first AC power source 211 may provide an AC power supply of 3.7 kW based on a current of 16 A and a voltage of 230V, and the second AC power source 212 may provide an AC power supply of 3.7 kW based on a current of 16 A and a voltage of 230V. Accordingly, the first heating area 110 may provide the maximum low power of 3.7 kW, the second heating area 120 may provide the maximum power of 1.4 kW, and the third heating area 130 may provide the maximum power of 2.3 kW.

Therefore, according to an embodiment of the disclosure, the heating device 100 may provide both of the high power of 5.5 kW, which is higher than 3.7 kW, which is a power capacity permitted for one power phase, and the low power of 3.7 kW or lower, which is a power capacity permitted for one power phase.

The switch 220 may selectively connect the second AC power source 212 with a second rectifier 232 of the first rectifying portion 230, according to a power level of the heating device 100. Accordingly, through the switch 220, an AC power supply from the second AC power source 212 may be selectively provided to the second rectifier 232. To selectively provide the AC power supply of the second AC power source 212 to the second rectifier 232 may be an operation of selectively providing, to the second rectifier 232, a power supply of one power phase (the AC power supply of the second AC power source 212) of power supplies of different power phases provided from the power source 210.

For example, when the power level of the heating device 100 is at a high-power level, the controller 270 may control a switching operation of the switch 220 such that the second AC power source 212 and the second rectifier 232 may be connected with each other. When the power level of the heating device 100 is not the high-power level, the controller 270 may control the switching operation of the switch 220 such that the second AC power source 212 and the second rectifier 232 may not be connected with each other, and the first AC power source 211 and the second rectifier 232 may be connected with each other. When the power level of the heating device 100 is not the high-power level, the controller 270 may control the switching operation of the switch 220 such that the first AC power source 211 and the second rectifier 232 may be connected with each other in order to provide an AC power supply of the first AC power source 211 to the second rectifier 232. That the power level of the heating device 100 is not the high-power level according to an embodiment of the disclosure may be an operation of providing a low-power level by using the first heating area 110. Thus, when the power level of the heating device 100 is at a low-power level, rather than the high-power level, the AC power supply of the first AC power source 211 may be provided to each of the first rectifier 231 and the second rectifier 232. Regardless of the power level of the heating device 100, the AC power supply of the first AC power source 211 may be provided to the first rectifier 231.

According to an embodiment of the disclosure, the low-power level provided by using the first heating area 110 may be set between Level 0 and Level 15. As the low-power level of the first heating area 110 is nearer to Level 15, higher currents may be supplied to the heating elements L1, L2, and L3 in order to generate high power. As the low-power level of the first heating area 110 is nearer to Level 0, lower currents may be supplied to the heating elements L1, L2, and L3.

For example, when the power level of the first heating area 110 is set as the low-power level, Level 15, the first AC power source 211 may supply a current of 9 A to the first rectifier 231 of the first rectifying portion 230 and may supply a current of 7 A to the second rectifier 232 of the first rectifying portion 230, in order to provide power of 3.7 kW through the first heating area 110. Accordingly, the heating device 100 may provide power of 2.1 kW by using the first heating element L1, may provide power of 0.8 kW by using the second heating element L2, and may provide power of 0.8 kW by using the third heating element L3. The currents supplied to the first rectifier 231 and the second rectifier 232 may be determined based on voltage values (e.g., 220V, 230V, etc.) supplied based on the first AC power source 211 and the second AC power source 212 and the power value of each of the first heating coil L1, the second heating coil L2, and the third heating coil L3.

When the power level of the first heating area 110 is set as the low-power level, Level 14, the amount of current supplied to the first rectifying portion 230 from the first AC power source 211 may be reduced, in order to provide power of 3.4 kW by using the first heating area 110. For example, the first AC power source 211 may supply a current of 8.7 A to the first rectifier 231 and may supply a current of 6 A to the second rectifier 232. Accordingly, the heating device 100 may provide power of 2 kW to the first heating element L1, may provide power of 0.7 kW to the second heating element L2, and may provide power of 0.7 kW to the third heating element L3. As described above, the power level of the heating device 100 may be defined based on a value of the current (or a magnitude of the current) that is supplied.

According to an embodiment of the disclosure, the switch 220 may include a switch unit. The switch 220 according to an embodiment of the disclosure may be turned on/off at a zero voltage by switching the AC power source. Thus, the risk of a switch fusion failure may be reduced than when a direct current (DC) power source is switched.

The first rectifying portion 230 according to an embodiment of the disclosure may generate a DC power supply by rectifying an AC power supply received from the power source 210. The first rectifying portion 230 may include the first rectifier 231 and the second rectifier 232. Each of the first rectifier 231 and the second rectifier 232 may include a rectifier circuit (RC) converting an AC power supply to a DC power supply and a smoothing circuit (SC) evenly holding the DC power supply that is converted from the AC power supply. For example, the RC may be formed of four diodes having a full-bridge shape, and the SC may be formed of capacitors connected in parallel to two ends, but the structures of the RC and the SC are not limited thereto.

The first rectifying portion 230 may include the first rectifier 231 and the second rectifier 232, and thus, regardless of the power level of the first heating area 110, the current supplied to the first heating area 110 may be distributed.

For example, when high power is provided by using the first heating area 110, the first AC power source 211 may provide a current of 13 A to the first rectifier 231, and the second AC power source 212 may provide a current of 10.8 A to the second rectifier 232 through the switch 220. Here, the second AC power source 212 may supply a current of 5.2 A to a third rectifier 241 included in the second rectifying portion 240. Also, when low power (the low-power level, Level 15) is provided by using the first heating area 110, the first AC power source 211 may supply a current of 7 A to the second rectifier 232 while supplying a current of 9 A to the first rectifier 231. Here, the second AC power source 212 may supply a current of 16 A to the third rectifier 241. A value of the current supplied to the third rectifier 241 may be determined based on a value of a voltage supplied from the second AC power source 212 and a power value of each of the fourth heating element L4 and the fifth heating element L5.

According to an embodiment of the disclosure, the current supplied to the first heating area 110 may be distributed based on the first rectifier 231 and the second rectifier 232 included in the first rectifying portion 230, and thus, the heating temperature of the first rectifying portion 230 may be distributed, so as to improve the power holding time with respect to the first heating area 110. According to an embodiment of the disclosure, to improve the power holding time may denote to increase the power holding time.

The second rectifying portion 240 may include the third rectifier 241. The third rectifier 241 may generate a DC power supply by rectifying the AC power supply of the second AC power source 212. The third rectifier 241 may include an RC converting an AC power supply to a DC power supply and an SC evenly holding the DC power supply that is converted from the AC power supply. For example, the RC may be formed of four diodes having a full-bridge shape, and the SC may be formed of capacitors connected in parallel to two ends, but the structures of the RC and the SC are not limited thereto.

According to an embodiment of the disclosure, values of the currents supplied to the first rectifier 231, the second rectifier 232, and the third rectifier 241 may vary according to the power level of the heating device 100. For example, as the power level of the first heating area 110, the second heating area 120, and the third heating area 130 is higher, the values of the currents supplied to the first rectifier 231, the second rectifier 232, and the third rectifier 241 may be increased.

Power values of the first heating area 110, the second heating area 120, and the third heating area 130 may be predetermined and used. Even when power supplies of the power source 210 are changed depending on regions, the controller 270 may obtain a power value (P=V*I, P: power, V: voltage, and I: current or first power value) by using sensed values of a voltage and a current which are input to the first rectifying portion 230 and the second rectifying portion 240, may obtain a power value (or a second power value) predetermined with respect to the first to third heating areas 110 to 130, may compare the first power value with the second power value, and when the first power value and the second power value are different from each other, may control first to fourth coil driving circuits 251, 252, 261, and 266 such that the first power value reaches the second power value. The controller 270 may obtain the predetermined power value (the second power value) of the first heating area 110, the second heating area 120, and the third heating area 130 from the storage 275. To this end, the storage 275 may store the predetermined power value (the second power value) of the first heating area 110, the second heating area 120, and the third heating area 130.

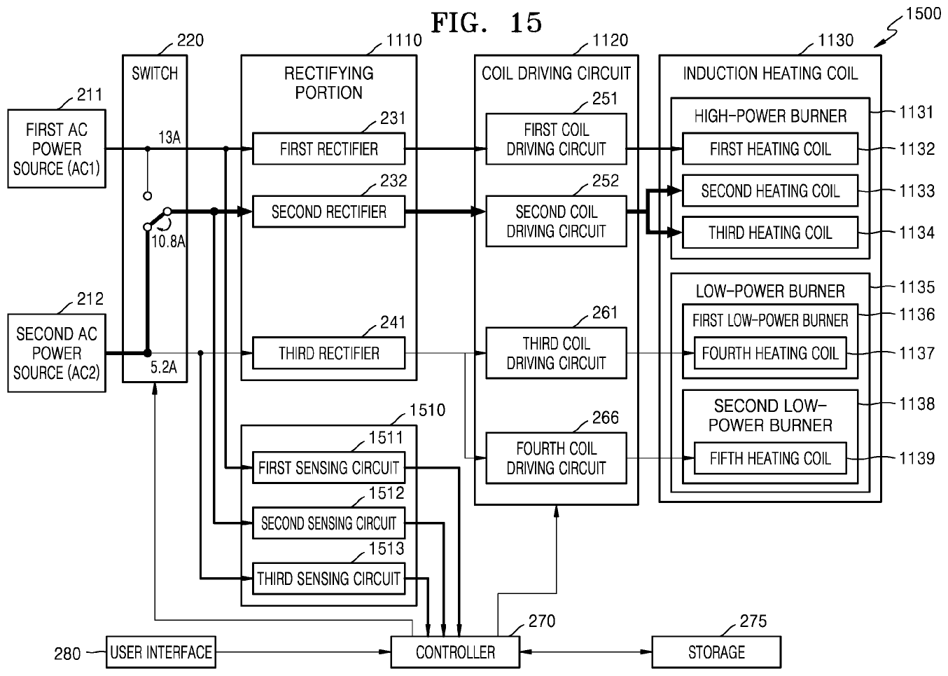

To obtain the sensed values of the voltage and the current that are input to the first rectifying portion 230 and the second rectifying portion 240, the heating device 100 may include a sensing circuit 1510 illustrated in FIG. 15 below. The power supplies which may be provided through the power source 210 according to the regions may be, for example, 230V, 220V, or 240V. However, the power supplies which may be provided are not limited thereto. Accordingly, the heating device 100 according to the disclosure may provide higher power than the limit of a power capacity by using the first heating area 110 even in a region having a limit in power capacity.

The storage 275 according to an embodiment of the disclosure may store a table in which information about a power level and a power value of each of the first heating area 110, the second heating area 120, and the third heating area 130 are mapped to each other, the power value corresponding to the information about the power level. The information about the power level stored in the storage 275 may be represented, for example, as binary data corresponding to Power level 1 and Power level 2. The power value stored in the storage 275 may be represented as binary data corresponding to the power value represented as kw. The power value stored in the storage 275 may include the power value of each of the first to third heating areas 110 to 130 or/and the power value of each the heating elements included in the first to third heating areas 110 to 130.

The information about each power level included in the table stored in the storage 275 according to an embodiment of the disclosure may include information about a high-power level and low-power levels, Level 0 to Level 15, with respect to the first heating area 110, the second heating area 120, and the third heating area 130, and the power value may include information corresponding to 5.5 kW to 0 kW. However, the information about each power level and the power value are not limited thereto.

The first coil driver 250 according to an embodiment of the disclosure may provide a high-frequency power supply to the heating elements L1, L2, and L3 included in the first heating area 110 by converting an introduced DC power supply to the high-frequency power supply. The first coil driver 250 may include a first coil driving circuit 251 and a second coil driving circuit 252. The first coil driving circuit 251 may provide, to the first heating element L1 included in the first heating area 110, a high-frequency power supply, by converting a DC power supply provided from the first rectifier 231 to the high-frequency power supply. The second coil driving circuit 252 may provide, to each of the first heating element L2 and the second heating element L3 included in the first heating area 110, a high-frequency power supply, by converting a DC power supply provided from the second rectifier 232 to the high-frequency power supply.

The first coil driving circuit 251 according to an embodiment of the disclosure may be controlled by the controller 270 and may adjust a magnitude and an operating frequency of the high-frequency power supply supplied to the first heating element L1, according to a power level of the first heating area 110. The second coil driving circuit 252 may be controlled by the controller 270 and may adjust a magnitude and an operating frequency of the high-frequency power supply supplied to the second heating element L2 and the third heating element L3, according to a power level of the first heating area 110.

The operations of the first coil driving circuit 251 and the second coil driving circuit 252 may be controlled by the controller 270 according to sub-heating areas that are set with respect to the first to third heating elements L1 to L3 included in the first heating area 110. For example, when different sub-heating areas are set with respect to the first heating element L1 and the second and third heating elements L2 and L3 from each other and the power level with respect to the first heating area 110 is set such that only the first heating element L1 is driven, the controller 270 may control the second coil driving circuit 252 not to operate. When the power level with respect to the first heating area 110 is set such that only the second heating element L2 is driven, the controller 270 may control the second coil driving circuit 252 to provide only a current required by the second heating element L2. When the power level with respect to the first heating area 110 is set such that only the third heating element L3 is driven, the controller 270 may control the second coil driving circuit 252 to provide only a current required by the third heating element L3. The second coil driving circuit 252 may selectively drive the second heating element L2 and the third heating element L3 according to control by the controller 270.

According to the power level of the first heating area 110, the controller 270 may adjust a magnitude and an operating frequency of a high-frequency power supply to be generated by the first coil driving circuit 251 and the second coil driving circuit 252. For example, based on a control signal (for example, an operating frequency command) provided from the controller 270, the first coil driving circuit 251 may provide a high-frequency power supply to the first heating element L1 connected to the first coil driving circuit 251 by converting a DC power supply to the high-frequency power supply and the second coil driving circuit 252 may provide a high-frequency power supply to the second heating element L2 and the third heating element L3 connected to the second coil driving circuit 252 by converting a DC power supply to the high-frequency power supply.

The second coil driving circuit 252 may set a heating element having a priority order, based on the power supply to be consumed by the second heating element L2 and the third heating element L3, and the second coil driving circuit 252 may supply, to the heating element having the priority order, a current corresponding to the power supply required by the corresponding heating element and may supply, to the remaining heating element, a current corresponding to the remaining power supply. For example, when the first heating area 110 is high power and a power supply of 2.5 kW is provided to the second heating element L2 and the third heating element L3, the second coil driving circuit 252 may provide a current corresponding to the same power supply to the second heating element L2 and the third heating element L3, but may provide a current corresponding to a higher power supply to a heating element having a priority order based on the prioritization of the heating element.

The priority order according to an embodiment of the disclosure may be determined according to a size of a cooking vessel placed in the first heating area 110 or a location of the heating element. As illustrated in FIG. 1, the second heating element L2 is placed more inside than the third heating element L3, and thus, the second heating element L2 may have a higher priority order than the third heating element L3. When the second heating element L2 has a higher priority order than the third heating element L3, the second coil driving circuit 252 may supply a current corresponding to a high-frequency power supply of 1.5 kW to the second heating element L2 and may supply a current corresponding to a high-frequency power supply of 1 kW to the third heating element L3.

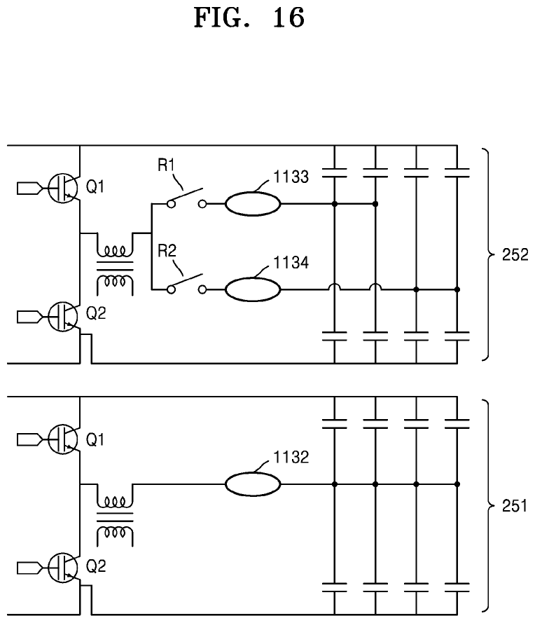

The first to fourth coil driving circuits 251, 252, 261, and 266 may be formed in the form of a single switch. The first coil driving circuit 251 may have a half-bridge form including a pair of serially connected switches and a pair of serially connected capacitors. For example, the first coil driving circuit 251 may have the half-bridge form as illustrated in FIG. 16. The first coil driving circuit 251 may have a full-bridge form in which a pair of serially connected switches are connected to another pair of serially connected switches, in parallel. The first to fourth coil driving circuits 251, 252, 261, and 266 may be formed as an inverter. An inverter may be an electrical conversion device for converting a DC component to an AC component.

The first coil driving circuit 251 may be connected to the first heating element L1, and the second coil driving circuit 252 may be connected to the second heating element L2 and the third heating element L2. According to an embodiment of the disclosure, the number of first coil driving circuits 251 and the number of second coil driving circuits 252, the first coil driving circuits 251 and the second coil driving circuits 252 being included in the first coil driver 250, may be changed according to the number of heating elements included in the first heating area 110. The heating device 100 according to an embodiment of the disclosure may be implemented such that the number of coil driving circuits included in the first coil driver 250 is less than the number of heating elements included in the first heating area 110, so as to have improved price competitiveness.

The second coil driver 260 according to an embodiment of the disclosure may include the third coil driving circuit 261. When a DC power supply is supplied from the third rectifier 241, the third coil driving circuit 261 may provide a current required by the fourth heating element L4 included in the second heating area 120. For example, the third coil driving circuit 261 may provide a high-frequency power supply to the fourth heating element L4 by converting a supplied DC power supply to the high-frequency power supply. The third coil driving circuit 261 may be controlled by the controller 270 according to a power level of the second heating area 120 and may control a current supplied to the fourth heating element L4. According to an embodiment of the disclosure, the number of third coil driving circuits 261 included in the second coil driver 260 may be changed according to the number of heating elements included in the second heating area 120.

The third coil driver 265 according to an embodiment of the disclosure may include the fourth coil driving circuit 266. The fourth coil driving circuit 266 may be connected to the fifth heating element L5. When a DC power supply is supplied from the third rectifier 241, the fourth coil driving circuit 266 included in the third coil driver 265 may provide a current required by the fifth heating element L5 included in the third heating area 130. For example, the fourth coil driving circuit 266 may provide a high-frequency power supply to the fifth heating element L5 by converting a supplied DC power supply to a high-frequency power supply. The fourth coil driving circuit 266 may be controlled by the controller 270 according to a power level of the third heating area 130 and may control a current supplied to the fifth heating element L5. According to an embodiment of the disclosure, the number of fourth coil driving circuits 266 included in the third coil driver 265 may be changed according to the number of heating elements included in the third heating area 130.

The first heating area 110 may include the first heating element L1, the second heating element L2, and the third heating element L3. The first heating element L1 may be connected to the first coil driving circuit 251, and thus, when an AC current based on the high-frequency power supply is supplied to the first heating element L1 from the first coil driving circuit 251, a magnetic field may be induced in the first heating element L1. The magnetic field induced in the first heating element L1 may pass through a bottom surface of a cooking vessel placed in the first heating area 110 and may generate an eddy current in the cooking vessel according to Faraday's law. The second heating element L2 and the third heating element L3 may be connected to the second coil driving circuit 252, and thus, when an AC current based on the high-frequency power supply is supplied to the second heating element L2 and the third heating element L3 from the second coil driving circuit 252, a magnetic field may be induced in the second heating element L2 and the third heating element L3. The magnetic field induced in the second heating element L2 and the third heating element L3 may pass through the bottom surface of the cooking vessel placed in the first heating area 110 and may generate an eddy current in the cooking vessel according to Faraday's law. The cooking vessel may be referred to as a heating device.

The second heating area 120 may include the fourth heating element L4. The fourth heating element L4 may be connected to the third coil driving circuit 261, and thus, when an AC current based on the high-frequency power supply is supplied to the fourth heating element L4 from the third coil driving circuit 261, a magnetic field may be induced in the fourth heating element L4. The magnetic field induced in the fourth heating element L4 may pass through a bottom surface of the cooking vessel placed in the second heating area 120 and may generate an eddy current in the cooking vessel according to Faraday's law.

The third heating area 130 may include the fifth heating element L5. The fifth heating element L5 may be connected to the fourth coil driving circuit 266, and thus, when an AC current based on the high-frequency power supply is supplied to the fifth heating element L5 from the fourth coil driving circuit 266, a magnetic field may be induced in the fifth heating element L5. The magnetic field induced in the fifth heating element L5 may pass through a bottom surface of the cooking vessel placed in the third heating area 130 and may generate an eddy current in the cooking vessel according to Faraday's law.

The first to fifth heating elements L1 to L5 included in the first to third heating areas 110 to 130 according to an embodiment of the disclosure may be configured to correspond to a heating device (a cooking vessel) configured to generate heat based on a reception coil.

The user interface 280 according to an embodiment of the disclosure may be mounted on a surface of the heating device 100 and may not only receive an input of a power supply and a control command such as operation resumption/suspension, etc., but may also receive a power level setting command for adjusting a power value of the first heating area 110 and the second and third heating areas 120 and 130, from a user.

The power level setting command may include, for example, a high-power level setting command and a low-power level setting command.

When the high-power level setting command is received through the user interface 280, the controller 270 may perform a high-power operation of the heating device 100 such that high power may be provided through the first heating area 110. That the heating device 100 performs the high-power operation may denote that the power level of the heating device 100 is at a high-power level.

When the low-power level setting command is received through the user interface 280, the controller 270 may perform a low-power operation of the heating device 100 such that low power may be provided through the first heating area 110. That the heating device 100 performs the low-power operation may denote that the power level of the heating device 100 is at a low-power level.

The user interface 280 according to an embodiment of the disclosure may include a component configured to receive various control commands from a user and a display displaying, for the user, an operation state of the heating device 100 or allowing the user to recognize a received command. The component configured to receive various control commands may be realized by using various input devices, such as a physical button, a touch button, a knob, a jog shuttle, a manipulation stick, a trackball, and a trackpad. The user interface 280 according to an embodiment of the disclosure may be configured to receive information about the maximum power value of the first heating area 110 and provide the received information about the maximum power value to the controller 270.

The display included in the user interface 280 according to an embodiment of the disclosure may be realized by using a liquid crystal display (LCD), a light-emitting diode (LED), an organic LED (OLED), or the like.

The user interface 280 may include, for example, a power button, a burner selection button (or a heating area selection button), a power level adjusting button (or a power level setting button), a warmth-keeping button, and a timer button. Some of these buttons may be omitted according to selection by a designer, and other buttons in addition to these buttons may be further added according to selection by a designer.

The storage 275 may store data and programs needed to control the heating device 100. For example, the storage 275 may store information in which power data (or power information) corresponding to a power value provided by using the first to third heating areas 110 to 130 is mapped to power level information. The controller 270 may determine a driving current supplied to the first to fifth heating elements L1 to L5 included in the first to third heating areas 110 to 130 according to a power level of the first to third heating areas 110 to 130 by using the power data stored in the storage 275. According to an embodiment of the disclosure, the driving current supplied to the first to fifth heating elements L1 to L5 may be determined by the controller 270 by using a power value obtained based on a voltage value and a current value input to the first rectifying portion 230 and the second rectifying portion 240 and a power value predetermined with respect to the first to third heating areas 110 to 130, as in the case of a sensing circuit 1510 of FIG. 15 below.

Also, when a user command received through the user interface 280 requests high power through the first heating area 110, the storage 275 may store data for controlling an operation of the switch 220 in order to supply an AC power supply of a different power phase (an AC power supply of the second AC power source 212) to the second rectifier 232.

The storage 275 according to an embodiment of the disclosure may include read-only memory (ROM), fast random-access memory (RAM), a magnetic disk storage device, a non-volatile memory such as a flash memory, or a nonvolatile semiconductor memory device. For example, the storage 275 may use, as a semiconductor memory device, a secure digital (SD) memory card, a secure digital high capacity (SDHC) memory card, a mini SD memory card, a mini SDHC memory card, a transflash (TF) memory card, a micro SD memory card, a micro SDHC memory card, a memory stick, a compact flash (CF) memory card, a multi-media card (MMC), an MMC micro memory card, an extreme digital (XD) card, etc. Thus, the storage 275 may be referred to as a memory. Also, the storage 275 may include a network-attached storage device accessed through a network.

The communicator 290 may be connected to a network by using wires or wirelessly and may communicate with an external device. The external device may be a device having a communication channel that is set with the heating device 100. The external device may correspond to at least one of a home server, a different server connected to the home server, and other home appliances in a household. The communicator 290 may perform data communication according to the standards of the home server.

Through the network, the communicator 290 may transmit and receive data related to remote adjusting and may transmit and receive information, etc. related to an operation of other home appliances. Furthermore, the communicator 290 may receive information about a user's daily life pattern from the server and may use the information for an operation of the heating device 100. Also, the communicator 290 may not only perform data communication with the server or a remote controller in the household, but may also perform data communication with a portable terminal of a user.

The communicator 290 may be connected to the network by using wires or wirelessly and may transmit and receive data to and from the server, the remote controller, the portable terminal, or other home appliances. The communicator 290 may include one or more components for communicating with other external home appliances. For example, the communicator 290 may include a short-range wireless communication module, a wired communication module, and a mobile communication module.

The short-range wireless communication module may be a module for short-range wireless communication within a predetermined distance. The short-range wireless communication technique may include a wireless local area network (LAN), Wi-fi, Bluetooth, zigbee, Wi-fi direct (WFD), an ultra wideband (UWB), infrared data association (IrDA), Bluetooth low energy (BLE), or near-field communication (NFC), but is not limited thereto.

The wired communication module may denote a module for communication using an electrical signal or an optical signal. The wired communication technique may include a pair cable, a coaxial cable, an optical fiber cable, an Ethernet cable, or the like, but is not limited thereto.

The mobile communication module may transceive a wireless signal with at least one of a base station, an external terminal, and a server on a mobile communication network. The wireless signal may include a sound call signal, a video-telephony call signal, or various forms of data based on transmission and reception of text/multimedia messages.

The controller 270 according to an embodiment of the disclosure may control the overall operation of the heating device 100. The controller 270 may be indicated as a processor configured to control the overall operation of the heating device 100. The controller 270 may control operations of the heating device 100 based on a user command received through the user interface 280, and a power value of each heating area 110, 120, or 130 corresponding to power level information about each heating area 110, 120, or 130 predetermined in the storage 275, etc.

The controlling of the operations of the heating device 100 by the controller 270 may include controlling operations of the power source 210, the switch 220, the first rectifier 231 and the second rectifier 232 included in the first rectifying portion 230, the third rectifier 241 included in the second rectifying portion 240, the first coil driving circuit 251 and the second coil driving circuit 252 included in the first coil driver 250, the third coil driving circuit 261 included in the second coil driver 260, the fourth coil driving circuit 266 included in the third coil driver 265, the first heating element to the third heating element L1 to L3 included in the first heating area 110, the fourth heating element L4 included in the second heating area 120, the fifth heating element L5 included in the third heating area 130, the user interface 280, the storage 275, and the communicator 290.

The controller 270 may transmit, to each of various components included in the heating device 100, a control signal based on a user command received through the user interface 280 and a power value corresponding to power level information predetermined in the storage 275. The controller 270 may control signal flow of each of various components included in the heating device 100 and may process data. The controller 270 may control a magnitude and an operating frequency of a high-frequency power supply generated by transmitting a control signal corresponding to the power level input through the user interface 280 to each of the first coil driving circuit 251 and the second coil driving circuit 252 included in the first coil driver 250, the third coil driving circuit 261 included in the second coil driver 260, and the fourth coil driving circuit 266 included in the third coil driver 265. The controller 270 may control a switching operation for opening and closing the switch 220, based on the control signal corresponding to the power level input through the user interface 280.

Also, the controller 270 may control an operation of providing or an operation of blocking a driving power supply that is provided to the first to fifth heating elements L1 to L5 from the first to fourth coil driving circuits 251, 252, 261, and 266, in order to provide or block the driving power supply to a heating element included in a heating area that is required to an operation based on a user input received through the user interface 280.

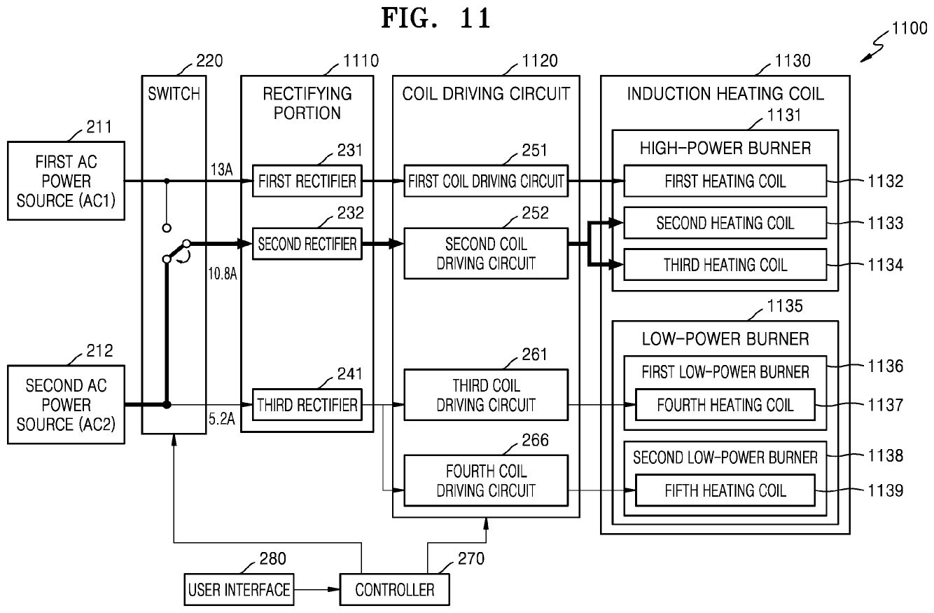

According to an embodiment of the disclosure, the first rectifying portion 230 and the second rectifying portion 240 may be formed as one rectifying portion including the first rectifier 231, the second rectifier 232, and the third rectifier 241 as illustrated in FIGS. 11 to 15 below. Even when the heating device 100 includes one rectifying portion including the first rectifier 231, the second rectifier 232, and the third rectifier 241, the first rectifier 231 and the second rectifier 232 of the rectifying portion may operate for the high-power heating area and the third rectifier 241 of the rectifying portion may operate for the low-power heating area according to a high-power level or a low-power level of the heating device 100, as described above.

In the heating device 100 according to an embodiment of the disclosure, the first rectifying portion 230, the first coil driver 250, and the first heating area 110 may be mounted on one printed circuit board (PCB) assembly (PBA). In the heating device 100, the second rectifying portion 240, the second coil driver 260, the third coil driver 265, the second heating area 120, and the third heating area 130 may be mounted on one PBA.

In the heating device 100 according to an embodiment of the disclosure, during a high-power operation and a low-power operation of the first heating area 110, a power supply provided from the second AC power source 212 may be selectively provided by using the switch 220 between the power source 210 and the first rectifying portion 230 so as to reduce the number of switch components, and thus, the price competitiveness of the heating device 100 may be improved.

Not all of the components illustrated in FIG. 2 are essential components of the heating device 100 according to an embodiment of the disclosure. The heating device 100 may be realized to include more components than the components illustrated in FIG. 2. The heating device 100 may be realized to include less components than the components illustrated in FIG. 2.

For example, the heating device 100 may include the power source 210, the switch 220, the first rectifying portion 230, the first coil driver 250, the first heating area 110, the controller 270, the storage 275, the user interface 280, and the communicator 290. When the heating device 100 is formed as described above, the heating device 100 may provide high power or low power based on the first heating area 110, which is a high-power heating area, and may provide notification information through the user interface 280 and the communicator 290. The notification information may include a notification message indicating a change of a power level of the heating device 100. The notification information may include a notification message indicating a power level set in the heating device 100.

Also, the heating device 100 may include the power source 210, the switch 220, the first rectifying portion 230, the first coil driver 250, the first heating area 110, the controller 270, and the user interface 280. When the heating device 100 is formed as described above, the heating device 100 may perform a high-power operation or a low-power operation based on the first heating area 110, which is a high-power heating area.

The heating device 100 may include the power source 210, the switch 220, the first rectifying portion 230, the first coil driver 250, the first heating area 110, the second rectifying portion 240, the second coil driver 260, the second heating area 120, the controller 270, and the user interface 280. When the heating device 100 is formed as described above, the heating device 100 may simultaneously perform a low-power operation based on the second heating area 120, which is a low-power heating area, while performing a high-power operation or the low-power operation based on the first heating area 110, which is a high-power heating area.

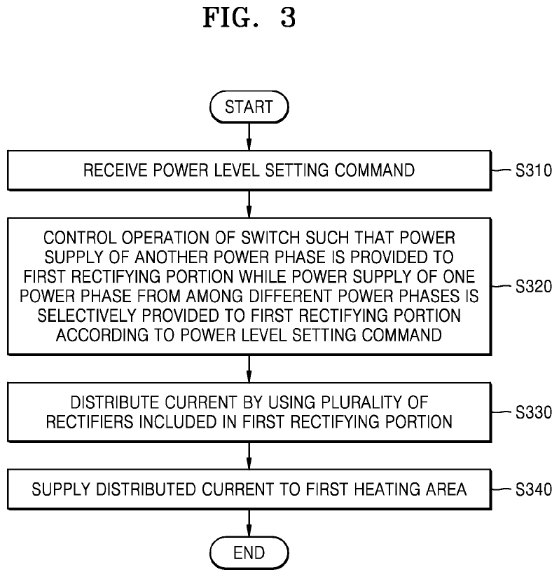

FIG. 3 is a flowchart for describing a power control method of the heating device 100, according to an embodiment of the disclosure.

In operation S310, the heating device 100 according to an embodiment of the disclosure may receive a power level setting command through the user interface 280. The power level setting command according to an embodiment of the disclosure may include a high-power level setting command and a low-power level setting command. The low-power level setting command may be a command to set one of a low-power level Level 0 to a low-power level Level 15 described in FIG. 2.

In operation S310, when the high-power level setting command is received, the heating device 100 may perform a high-power operation based on the first heating area 110. That the heating device 100 performs the high-power operation based on the first heating area 110 may denote that the power level of the heating device 100 is at a high-power level.

In operation S310, when the low-power level setting command is received, the heating device 100 may perform a low-power operation based on the first heating area 110. That the heating device 100 performs the low-power operation based on the first heating area 110 may denote that the power level of the heating device 100 is at a low-power level.

In operation S320, the heating device 100 according to an embodiment of the disclosure may operate to control an operation of the switch 220 to selectively supply, to the first rectifying portion 230, an AC power supply of one power phase from among different power phases according to the received power level setting command and may operate to supply, to the first rectifying portion 230, an AC power supply of another power phase from among the different power phases. For example, the heating device 100 may operate to selectively supply an AC power supply of the second AC power source 212 to the first rectifying portion 230 according to the power level setting command, while supplying an AC power supply of the first AC power source 211 to the first rectifying portion 230. The different power phases may be, for example, the AC power sources capable of supplying 3.7 kW power having a phase difference of 120 degrees and based on 230V at 16A, as described with reference to FIG. 2.

In operation S320, according to the received power level setting command, the heating device 100 may selectively supply the AC power supply of the second AC power source 212 to the first rectifying portion 230, while supplying the AC power supply of the first AC power source 211 to the first rectifying portion 230. That is, when the received power level setting command is the high-power level setting command, the heating device 100 may supply the AC power supply of the second AC power source 212 to the first rectifying portion 230, while supplying the AC power supply of the first AC power source 211 to the first rectifying portion 230. When the received power level setting command is the low-power level setting command, the heating device 100 may supply the AC power supply of the first AC power source 211 to the first rectifying portion 230 and may not supply the AC power supply of the second AC power source 212 to the first rectifying portion 230.

In operation S330, the heating device 100 may distribute a current by using the first rectifier 231 and the second rectifier 232 included in the first rectifying portion 230. The current distribution using the first rectifier 231 and the second rectifier 232 may be performed regardless of the power level of the heating device 100. In operation S340, the heating device 100 may supply the current distributed by the first rectifying portion 230 to the first heating area 110.

According to an embodiment of the disclosure, the flowchart of FIG. 3 may be performed by the controller 270 of the heating device 100.

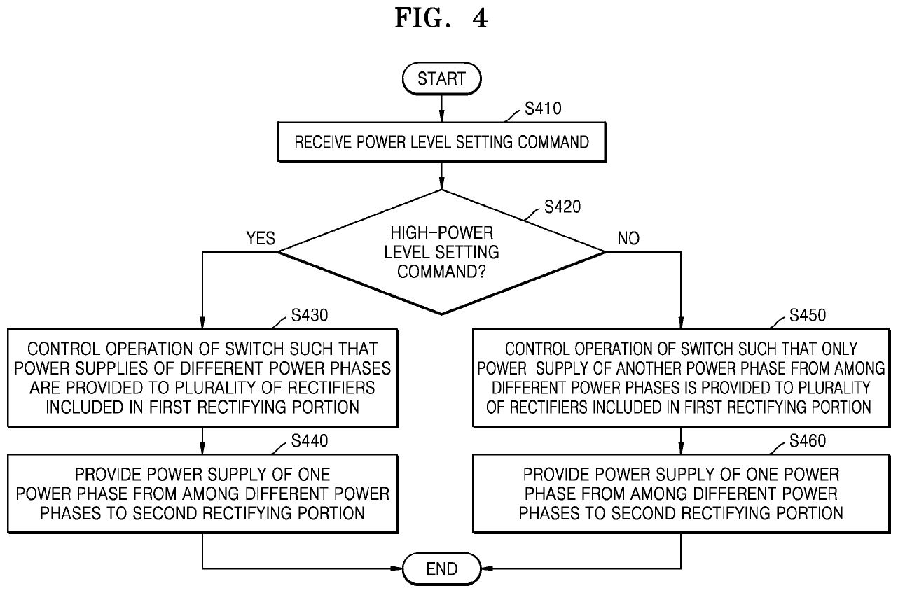

FIG. 4 is a flowchart for describing a switching operation according to a power level of the heating device 100 in a power control method of the heating device 100, according to an embodiment of the disclosure.

In operation S410, the heating device 100 may receive a power level setting command through the user interface 280. The power level setting command according to an embodiment of the disclosure may include a high-power level setting command and a low-power level setting command. The low-power level setting command may be a command to set one of a low-power level Level 0 to a low-power level Level 15 described in FIG. 2.

In operation S420, the heating device 100 according to an embodiment of the disclosure may determine whether or not the received power level setting command is a high-power level setting command.

When the heating device 100 determines that the received power level setting command is the high-power level setting command in operation S420, the heating device 100 may control an operation of the switch 220 to provide AC power supplies of different power phases to the first rectifying portion 230 in operation S430. In operation S440, the heating device 100 may provide an AC power supply of one power phase from among the different power phases to the second rectifying portion 240. For example, the heating device 100 may provide an AC power supply of the second AC power source 212 to the second rectifying portion 240 while controlling an operation of the switch 220 to provide an AC power supply of the first AC power source 211 and the AC power supply of the second AC power source 212 to the first rectifying portion 230.

When the received power level setting command is not the high-power level setting command in operation S420, the heating device 100 may control, in operation S450, an operation of the switch 220 to provide only a power supply of another power phase from among the different power phases to the first rectifier 231 and the second rectifier 232 included in the first rectifying portion 230. For example, the heating device 100 may control the operation of the switch 220 to provide only the AC power supply of the first AC power source 211 to the first rectifier 231 and the second rectifier 232 included in the first rectifying portion 230.

In operation S460, the heating device 100 may provide a power supply of one power phase from among the different power phases to the second rectifying portion 240. For example, the heating device 100 may provide the power supply of the second AC power source 212 to the second rectifying portion 240.

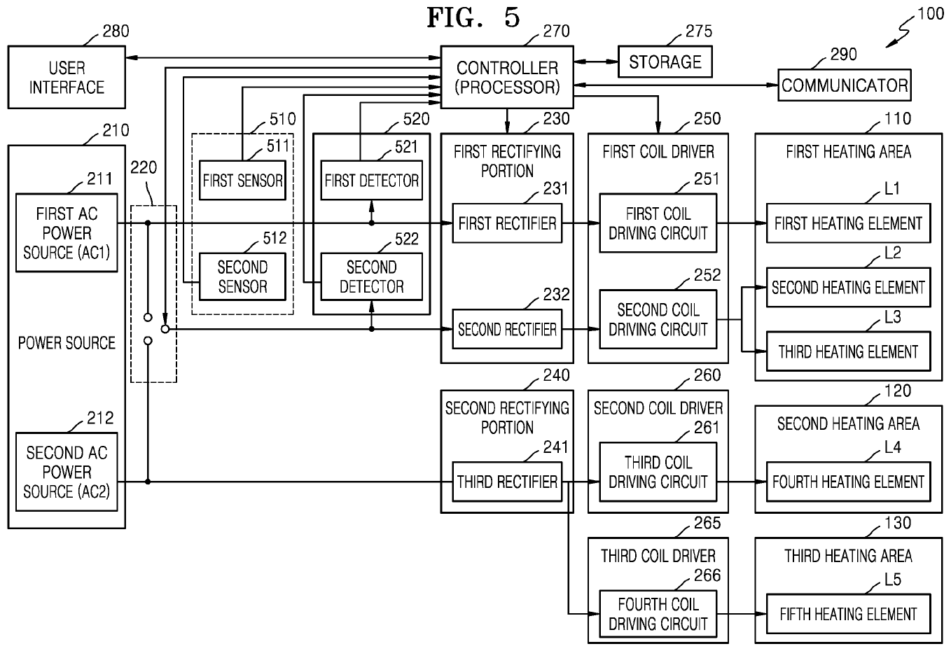

FIG. 5 is a functional block diagram for describing the heating device 100 according to an embodiment of the disclosure. FIG. 5 is an example in which a sensor portion 510 and a detecting portion 520 are further included in the heating device 100 of FIG. 2.

The sensor portion 510 may include a first sensor 511 and a second sensor 512 sensing temperatures of the first rectifier 231 and the second rectifier 232, respectively. The first sensor 511 may sense the temperature of the first rectifier 231, and the second sensor 512 may sense the temperature of the second rectifier 232. Temperature values sensed by the first sensor 511 and the second sensor 512 may be transmitted to the controller 270. The first sensor 511 and the second sensor 512 may be formed as negative temperature coefficient (NTC) temperature sensors or positive temperature coefficient (PTC) temperature sensors. The first sensor 511 and the second sensor 512 may be formed as electrical devices, the material resistance of which changes according to the temperature. The first sensor 511 and the second sensor 512 may be formed as electrical devices, the material resistance of which linearly changes according to the temperature. As illustrated in FIG. 5, the first sensor 511 and the second sensor 512 may be mounted in a position adjacent to the first rectifying portion 230 or may be mounted in a position adjacent to the first heating area 110, the second heating area 120, and the third heating area 130. The sensor portion 510 may be formed as one sensor capable of sensing a plurality of temperatures.

When it is determined that the temperature values transmitted from the first sensor 511 and the second sensor 512 have reached a predetermined value (for example, about 80 degrees), the controller 270 may reduce the current supplied to the corresponding rectifiers to suppress a temperature rise in the rectifiers. For example, when it is determined that the temperature value transmitted from the first sensor 511 has reached the predetermined value, the controller 270 may reduce the current supplied to the first rectifier 231. When it is determined that the temperature value transmitted from the second sensor 512 has reached the predetermined value, the controller 270 may reduce the current supplied to the second rectifier 232.

Accordingly, the heating device 100 may increase the power holding time with respect to the first heating area 110. For example, when high power is provided by using the first heating area 110, and when the temperatures transmitted from the first sensor 511 and the second sensor 512 have reached a predetermined value, the heating device 100 may control an operation of the switch 220 to provide low power by using the first heating area 110, in order to reduce the current supplied to the first rectifier 231 and the second rectifier 232. An operation of the switch 220 to change high power provided based on the first heating area 110 to low power may denote an operation of disconnecting the connection between the second AC power source 212 and the second rectifier 232 from each other and connecting the first AC power source 211 and the second rectifier 232 to each other. The operation of the switch 220 may be controlled by the controller 270.

The detecting portion 520 may detect a voltage or/and a current of the power source 210 that is/are input to the first rectifier 231 and the second rectifier 232 and may provide a detected result to the controller 270. For example, the detecting portion 520 may be configured to detect a zero voltage by using a zero-crossing switching method. For example, the detecting portion 520 may be formed as a comparator circuit.

The detecting portion 520 may include a first detector 521 configured to detect a zero voltage that is input to the first rectifier 231 and a second detector 522 configured to detect a zero voltage that is input to the second rectifier 232. According to an embodiment of the disclosure, the first detector 521 and the second detector 522 may be configured to detect, by using a zero-crossing switching method, a zero current that is input to each of the first rectifier 231 and the second rectifier 232.

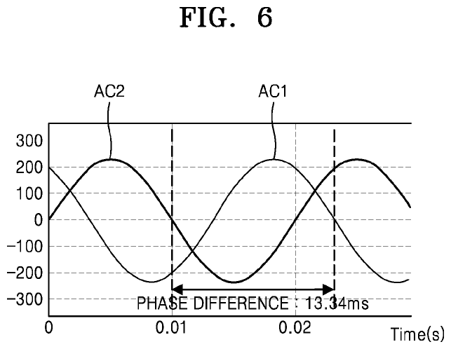

The controller 270 may monitor an operation error of the switch 220 based on the detected result from the first detector 521 and the second detector 522 included in the detecting portion 520. For example, when high power is provided by using the first heating area 110, the AC power supply of the first AC power source 211 and the AC power supply of the second AC power source 212 may be provided to the first rectifier 231 and the second rectifier 232, respectively, and thus, the zero voltage detected from each of the first detector 521 and the second detector 522 may have a time difference of about 13. 34 ms as illustrated in FIG. 6, when a frequency of the AC power supply provided by the power source 210 is 50 Hz. When a frequency of the AC power supply provided by the power source 210 is 60 Hz, a time difference between time points at which the zero voltages illustrated in FIG. 6 are detected may be, for example, about 11.11 ms. FIG. 6 is an example waveform diagram of a zero voltage detected when the heating device 100 performs a high-power operation through the first heating area 110.

Thus, when the frequency of the AC power supply provided by the power source 210 is 50 Hz, and when the difference between the time point at which the zero voltage is detected by the first detector 521 and the time point at which the zero voltage is detected by the second detector 522 is about 13.34 ms, the controller 270 may determine that the operation of the switch 220 is normal. However, when the frequency of the AC power supply provided by the power source 210 is 50 Hz, and when the difference between the time point at which the zero voltage is detected by the first detector 521 and the time point at which the zero voltage is detected by the second detector 522 is not about 13.34 ms, the controller 270 may determine that the operation of the switch 220 is abnormal. That the operation of the switch 220 is abnormal may denote that an error has occurred in the operation of the switch 220.

When the operation of the switch 220 is determined as abnormal, the controller 270 may control an operation of the switch 220 to stop the operation of the switch 220 for connecting the second AC power source 212 to the second rectifier 232 and simultaneously, may output notification information for notifying an error occurrence of the switch 220 through the user interface 280 or the communicator 290. The notification information that is output may be referred to as a notification message.

According to an embodiment of the disclosure, the notification information that is output may be a high power error, and thus, the notification information may include content notifying a necessity of a service request from a service center. The notification information that is output through the user interface 280 may be displayed through a display included in the user interface 280.

The notification information that is output through the communicator 290 may be output through at least one of external devices, for which a communication channel with the heating device 100 is set through the communicator 290. When a plurality of external devices are connected to the heating device 100 through the communicator 290, the heating device 100 may output the notification information through the plurality of external devices. When the plurality of external devices are connected to the heating device 100 through the communicator 290, the heating device 100 may output the notification information through an external device selected by the controller 270. For example, when the external device is a mobile device, the notification information may be output by using an output component (for example, a display or/and a speaker) included in the mobile device.

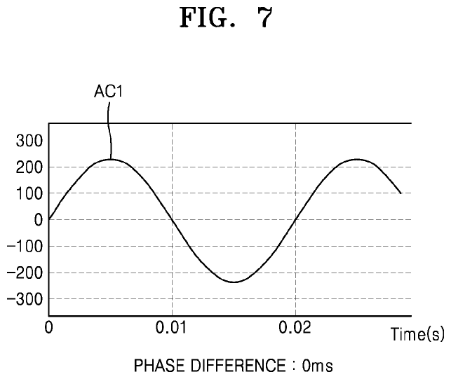

With respect to the zero voltages detected through the first detector 521 and the second detector 522 during a low-power operation through the first heating area 110, only the zero voltage with respect to a power supply provided through the first AC power source 211 may be detected, as illustrated in FIG. 7. FIG. 7 is an example waveform diagram of a zero voltage detected during a low-power operation of the heating device through the first heating area 110.

Thus, when the zero voltages are detected from the first detector 521 and the second detector 522 at the same time point, the controller 270 may determine an operation of the switch 220 as normal. However, when the zero voltages are not detected through the first detector 521 and the second detector 522 at the same time point, the controller 270 may determine an operation of the switch 220 as abnormal and may output the notification information notifying that the operation of the switch 220 is abnormal through the user interface 280 and the communicator 290 as described above.

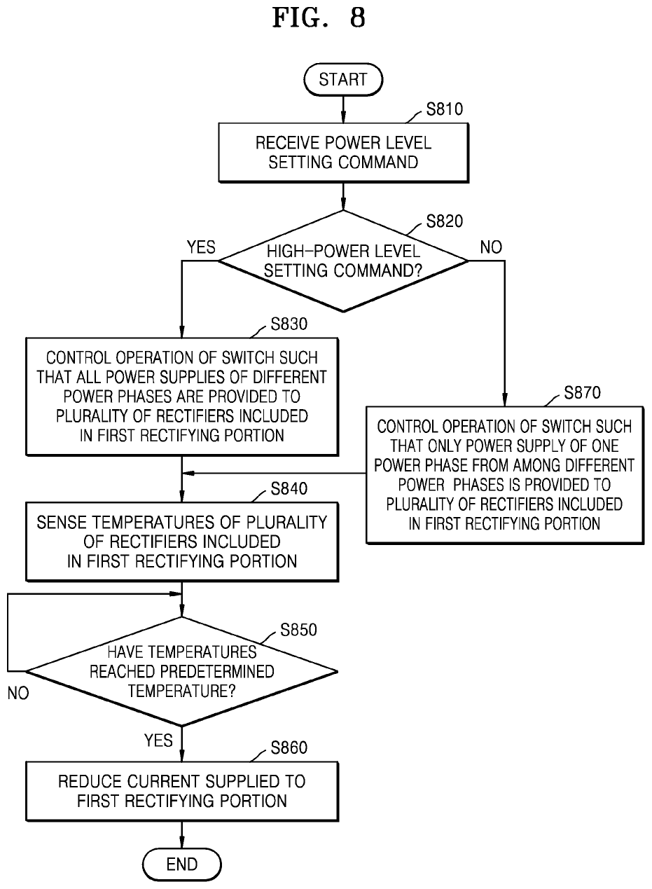

FIG. 8 is a flowchart for describing a power control method of the heating device 100, according to an embodiment of the disclosure.

In operation S810, the heating device 100 may receive a power level setting command. When the received power level setting command is determined as a high-power level setting command in operation S820, the heating device 100 may control, in operation S830, a switching operation of the switch 220 such that all AC power supplies of different power phases may be provided to the first rectifier 231 and the second rectifier 232 included in the first rectifying portion 230.

In operation S840, the heating device 100 may sense temperatures of the first rectifier 231 and the second rectifier 232 included in the first rectifying portion 230 by using the first sensor 511 and the second sensor 512. When the heating device 100 determines in operation S850 that temperature values sensed through the first sensor 511 and the second sensor 512 have reached a predetermined temperature (for example, about 80 degrees), the heating device 100 may control, in operation S860, an operation of the switch 220 such that a current supplied to the first rectifying portion 230 may be reduced. For example, the heating device 100 may control the operation of the switch 220 such that only an AC power supply of the first AC power source 211 may be supplied to the first rectifying portion 230. Accordingly, the heating device 100 may operate the first heating area 110 in a lower power level from a high-power level. The high-power level of the first heating area 110 may be an operation mode for providing high power through the first heating area 110. Thus, the high-power level of the first heating area 110 may be represented as a high-power operation mode of the first heating area 110. The low-power level of the first heating area 110 may be an operation mode for providing low power through the first heating area 110. Thus, the low-power level of the first heating area 110 may be represented as a low-power operation mode of the first heating area 110.

When the received power level setting command is determined as a low-power level setting command in operation S820, the heating device 100 may, in operation S870, control an operation of the switch 220 to provide an AC power supply of one power phase (for example, the AC power supply of the first AC power source 211) from among different power phases to each of the first rectifier 231 and the second rectifier 232 included in the first rectifying portion 230 and may perform operation S840.

The flowchart of FIG. 8 may be performed by the controller 270 of the heating device 100.

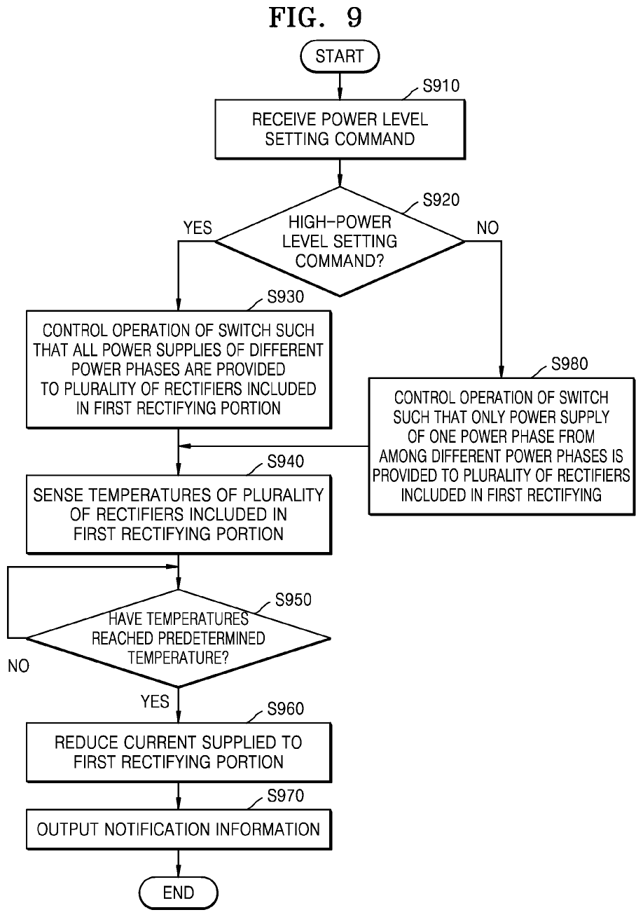

FIG. 9 is a flowchart for describing a power control method of the heating device 100, according to an embodiment of the disclosure. FIG. 9 is an example in which an operation of outputting notification information is added to the flowchart of FIG. 8. Thus, operations S910 to S960 and operation S980 in FIG. 9 may be performed likewise with operations S810 to S870 in FIG. 8.

In operation S970, the heating device 100 may output the notification information through at least one of the user interface 280 and the communicator 290. The notification information output in operation S970 may include content indicating that a power level of the first heating area 110 is changed or indicating that a power level provided through the first heating area 110 is lowered.

The flowchart of FIG. 9 may be performed by the controller 270 of the heating device 100.

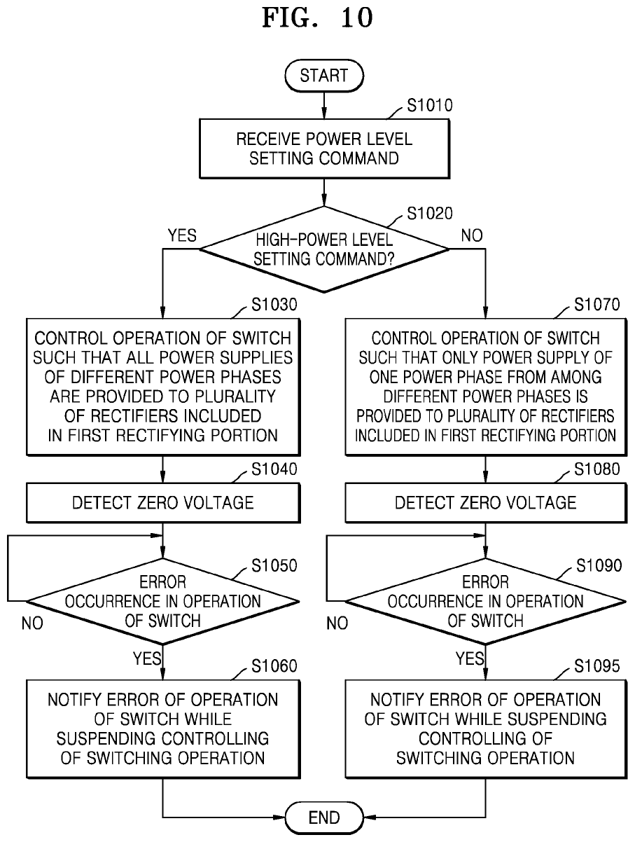

FIG. 10 is a flowchart for describing a power control method of the heating device 100, according to an embodiment of the disclosure.

In operation S1010, the heating device 100 may receive a power level setting command. When the received power level setting command is determined as a high-power level setting command in operation S1020, the heating device 100 may control, in operation S1030, an operation of the switch 220 such that all AC power supplies of different power phases may be provided to the first rectifier 231 and the second rectifier 232 included in the first rectifying portion 230.

In operation S1040, the heating device 100 may detect zero voltages from an input signal of the first rectifier 231 and an input signal of the second rectifier 232 as described with reference to FIGS. 5 and 6. For example, when a difference between a time point at which the first detector 521 detects the zero voltage and a time point at which the second detector 522 detects the zero voltage is about 13.34 ms, the heating device 100 may determine an operation of the switch 220 as normal. However, when the difference between the time point at which the first detector 521 detects the zero voltage and the time point at which the second detector 522 detects the zero voltage is not about 13.34 ms, the controller 270 may determine an operation of the switch 220 as abnormal.

When, in operation S1050, the operation of the switch 220 is determined as abnormal, in operation S1060, the heating device 100 may control an operation of the switch 220 to stop a switching operation for connecting the second AC power source 212 to the second rectifier 232 and at the same time, may output notification information for notifying an error occurrence of the switch 220 through the user interface 280 or the communicator 290.

When, in operation S1020, the received power level setting command is determined as a low-power level setting command, in operation S1070, the heating device 100 may control the switching operation of the switch 220 for connecting the first AC power source 211 to the second rectifier 232 in order to provide an AC power supply of one power phase (for example, the AC power supply of the first AC power source 211) from among different power phases to each of the first rectifier 231 and the second rectifier 232 included in the first rectifying portion 230.

In operation S1080, the heating device 100 may detect zero voltages from input signals of the first rectifier 231 and the second rectifier 232 as described with reference to FIGS. 5 and 7. That is, when the zero voltages are detected from the first detector 521 and the second detector 522 at the same time point, the heating device 100 may determine an operation of the switch 220 as normal in operation S1090. However, when the zero voltages are not detected from the first detector 521 and the second detector 522 at the same time point, the heating device 100 may determine an operation of the switch 220 as abnormal in operation S1090.

In operation S1095, the heating device 100 may perform a control operation to stop an operation of the switch 220 for connecting the first AC power source 211 to the second rectifier 232 and at the same time may output, through the user interface 280 or the communicator 290, notification information for notifying that the operation of the switch 220 is abnormal.

FIG. 11 is a block diagram for describing a function of a heating device 1100 according to an embodiment of the disclosure. FIG. 11 is the block diagram for describing the function of the heating device 1100 performing a high-power operation by using a high-power burner 1131. Thus, 13A supplied to the first rectifier 231, 10.8A supplied to the second rectifier 232, and 5.2A supplied to the third rectifier 241 illustrated in FIG. 11 are examples of current values supplied to the first to third rectifiers 231, 232, and 241 when the heating device 1100 performs the high-power operation by using the high-power burner 1131.

The heating device 1100 illustrated in FIG. 11 may include the first AC power source 211, the second AC power source 212, the switch 220, a rectifying portion 1110, a coil driving circuit 1120, an induction heating coil 1130, the controller 270, and the user interface 280. Components having the same reference numerals as the components illustrated in FIG. 2 from among the components illustrated in FIG. 11 may have the same structures and operations as the components illustrated in FIG. 2.

As the heating device 1100 performs the high-power operation by using the high-power burner 1131, the switch 220 illustrated in FIG. 11 may be controlled by the controller 270 and may perform an operation of connecting the second AC power source 212 with the second rectifier 232. Accordingly, an AC power supply from the second AC power source 212 may be provided to the second rectifier 232.

The rectifying portion 1110 may convert AC power supplies provided from the first AC power source 211 and the second AC power source 212 to DC power supplies and output the DC power supplies. The rectifying portion 1110 may include the first rectifier 231, the second rectifier 232, and the third rectifier 241 illustrated in FIG. 2.

The coil driving circuit 1120 may convert the DC power supplies provided from the rectifying portion 1110 to high-frequency power supplies and may provide the high-frequency power supplies to the induction heating coil 1130 to drive the induction heating coil 1130. The coil driving circuit 1120 may include the first coil driving circuit 251, the second coil driving circuit 252, the third coil driving circuit 261, and the fourth coil driving circuit 266 illustrated in FIG. 2.

The induction heating coil 1130 may include the high-power burner 1131 and a low-power burner 1135. The high-power burner 1131 may correspond to the first heating area 110 illustrated in FIG. 2.

The high-power burner 1131 may include a first heating coil 1132, a second heating coil 1133, and a third heating coil 1134. The first heating coil 1132 may correspond to the first heating element L1 illustrated in FIG. 2. The second heating coil 1133 may correspond to the second heating element L2 illustrated in FIG. 2. The third heating coil 1134 may correspond to the third heating element L3 illustrated in FIG. 2.

The low-power burner 1135 may include a first low-power burner 1136 and a second low-power burner 1138. The first low-power burner 1136 may correspond to the second heating area 120 illustrated in FIG. 2. The first low-power burner 1136 may include a fourth heating coil 1137. The fourth heating coil 1137 may correspond to the fourth heating element L4 illustrated in FIG. 2. The second low-power burner 1138 may correspond to the third heating area 130 illustrated in FIG. 2. The second low-power burner 1138 may include a fifth heating coil 1139. The fifth heating coil 1139 may correspond to the fifth heating element L5 illustrated in FIG. 2.

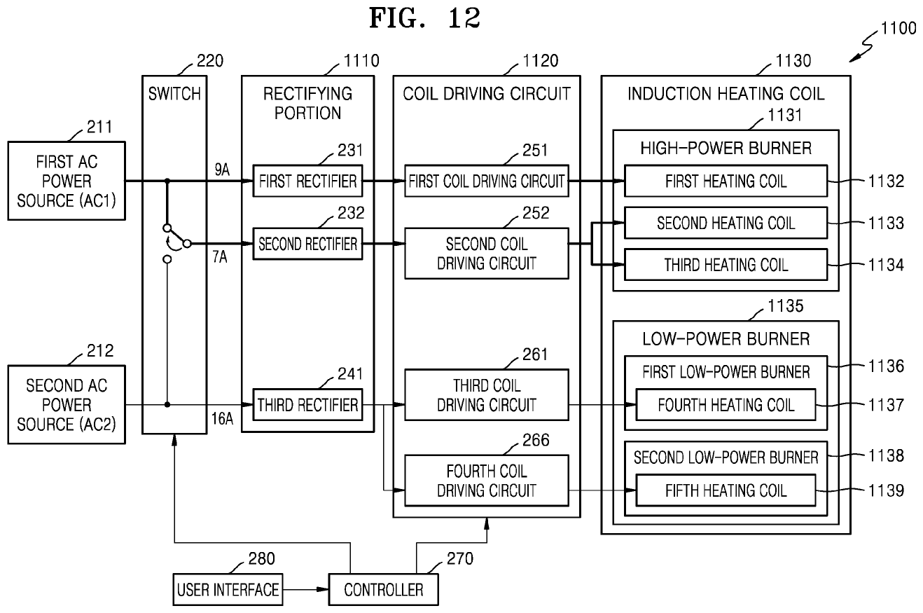

FIG. 12 is a block diagram for describing a function of the heating device 1100 according to an embodiment of the disclosure and is the block diagram for describing the function of the heating device 1100 performing a low-power operation by using the high-power burner 1131. Thus, 9A supplied to the first rectifier 231, 7A supplied to the second rectifier 232, and 16A supplied to the third rectifier 241 illustrated in FIG. 12 are examples of current values supplied to the first to third rectifiers 231, 232, and 241 when the heating device 1100 performs the low-power operation by using the high-power burner 1131.

As the heating device 1100 performs the low-power operation by using the high-power burner 1131, the switch 220 illustrated in FIG. 12 may be controlled by the controller 270 and may operate to connect the first AC power source 211 to the second rectifier 232. Accordingly, an AC power supply from the first AC power source 211 may be provided to the second rectifier 232.

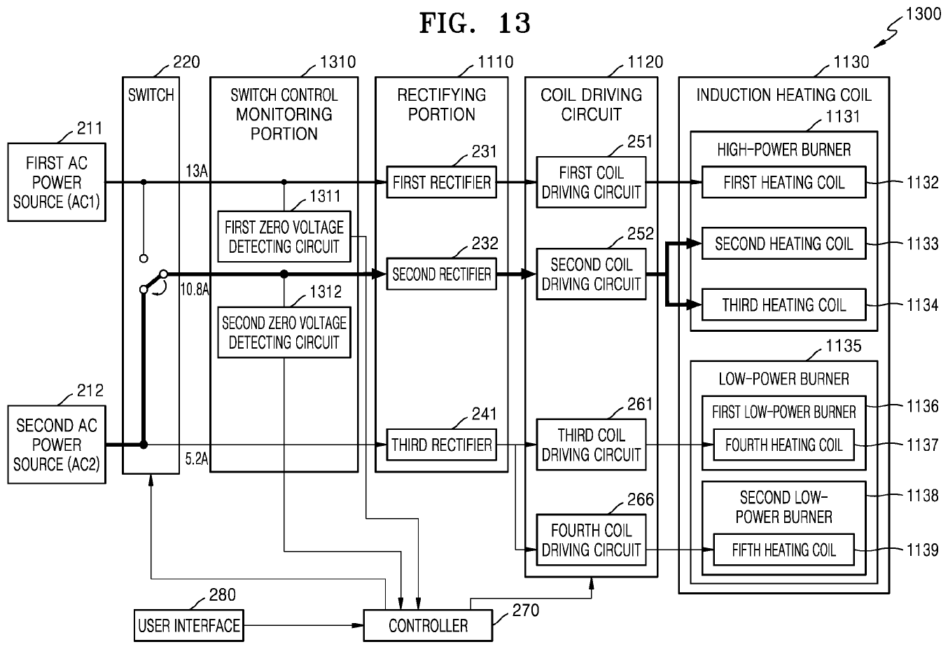

FIG. 13 is a block diagram for describing a function of a heating device 1300 according to an embodiment of the disclosure and is the block diagram for describing the function of the heating device 1300 performing a high-power operation by using the high-power burner 1131. Thus, 13A supplied to the first rectifier 231, 10.8A supplied to the second rectifier 232, and 5.2A supplied to the third rectifier 241 illustrated in FIG. 13 are examples of current values supplied to the first to third rectifiers 231, 232, and 241 when the heating device 1100 performs the high-power operation by using the high-power burner 1131.

FIG. 13 is the block diagram adding a switch control monitoring portion 1310 to the block diagram of the heating device 1100 illustrated in FIG. 11. The switch control monitoring portion 1310 may correspond to the detecting portion 520 illustrated in FIG. 5. The switch control monitoring portion 1310 may include a first zero voltage detecting circuit 1311 and a second zero voltage detecting circuit 1312. The first zero voltage detecting circuit 1311 may correspond to the first detector 521 illustrated in FIG. 5. The second zero voltage detecting circuit 1312 may correspond to the second detector 522 illustrated in FIG. 5.

The switch control monitoring portion 1310 may detect voltages input to the first rectifier 231 and the second rectifier 232 and may provide detected results to the controller 270. The first zero voltage detecting circuit 1311 may detect a zero voltage input to the first rectifier 231 and may provide a detected result to the controller 270. The second zero voltage detecting circuit 1312 may detect a zero voltage input to the second rectifier 232 and may provide a detected result to the controller 270.

FIG. 13 illustrates the case where the high-power burner 1131 of the heating device 1300 performs the high-power operation, and thus, the controller 270 may determine that an operation of the switch 220 is normal, when a time difference between a time point at which the first zero voltage detecting circuit 1311 detects the zero voltage and a time point at which the second zero voltage detecting circuit 1312 detects the zero voltage is, for example, about 13.34 ms, as illustrated in FIG. 6.

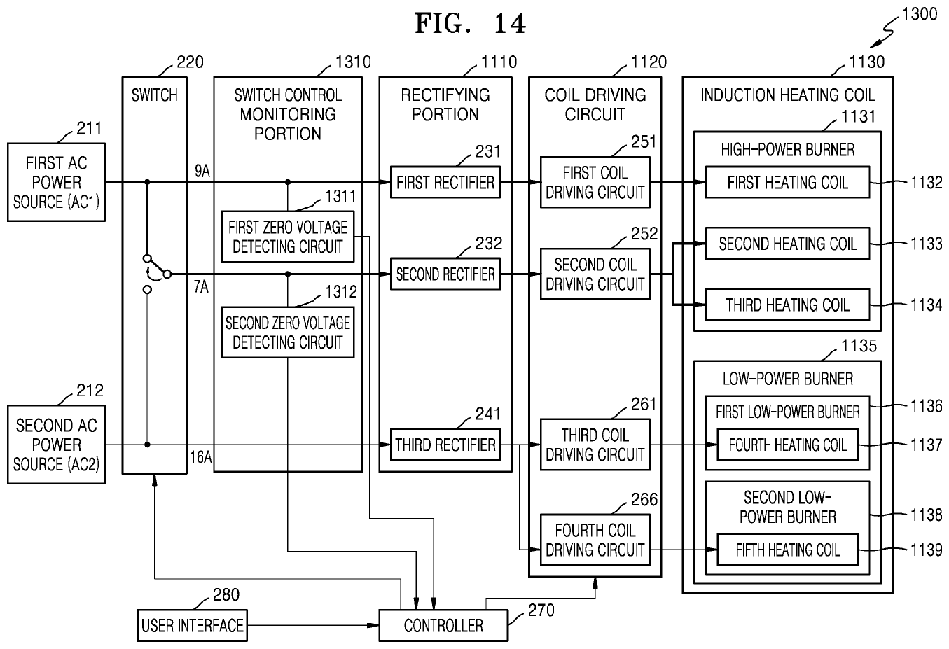

FIG. 14 is a block diagram for describing a function of the heating device 1100 according to an embodiment of the disclosure and is the block diagram for describing the function of the heating device 1100 performing a low-power operation by using the high-power burner 1131. Thus, 9A supplied to the first rectifier 231, 7A supplied to the second rectifier 232, and 16A supplied to the third rectifier 241 illustrated in FIG. 14 are examples of current values supplied to the first to third rectifiers 231, 232, and 241 when the heating device 1100 performs the low-power operation by using the high-power burner 1131.

As the heating device 1100 performs the low-power operation by using the high-power burner 1131, the switch 220 illustrated in FIG. 14 may be controlled by the controller 270 and may operate to connect the first AC power source 211 to the second rectifier 232. Accordingly, an AC power supply may be provided from the first AC power source 211 to the second rectifier 232.

Also, FIG. 14 is the block diagram in which the switch control monitoring portion 1310 is further included to the block diagram of the heating device 1100 illustrated in FIG. 12. The switch control monitoring portion 1310 may correspond to the detecting portion 520 illustrated in FIG. 5. The switch control monitoring portion 1310 may include the first zero voltage detecting circuit 1311 and the second zero voltage detecting circuit 1312. The first zero voltage detecting circuit 1311 may correspond to the first detector 521 illustrated in FIG. 5. The second zero voltage detecting circuit 1312 may correspond to the second detector 522 illustrated in FIG. 5.

The switch control monitoring portion 1310 may detect voltages input to the first rectifier 231 and the second rectifier 232 and may provide detected results to the controller 270. The first zero voltage detecting circuit 1311 may detect a zero voltage input to the first rectifier 231 and may provide a detected result to the controller 270. The second zero voltage detecting circuit 1312 may detect a zero voltage input to the second rectifier 232 and may provide a detected result to the controller 270.

FIG. 14 illustrates the case where the high-power burner 1131 of the heating device 1300 performs the low-power operation, and thus, the controller 270 may determine that an operation of the switch 220 is normal, when a time difference between a time point at which the first zero voltage detecting circuit 1311 detects the zero voltage and a time point at which the second zero voltage detecting circuit 1312 detects the zero voltage is 0, as illustrated in FIG. 7. This may be because the AC power supplies from the first AC power source 211 are supplied to the first rectifier 231 and the second rectifier 232 through the switch 220.

FIG. 15 is a block diagram for describing a function of a heating device 1500 according to an embodiment of the disclosure and illustrates a case where the high-power burner 1131 performs a high-power operation. The block diagram of the heating device 1500 illustrated in FIG. 15 is an example in which a sensing circuit 1510 is further added to the block diagram of the heating device 1100 of FIG. 11.

The sensing circuit 1510 may provide, to the controller 270, values of sensing a voltage value and a current value that are input to the first rectifier 231, the second rectifier 232, and the third rectifier 241 included in the rectifying portion 1110. To this end, the sensing circuit 1510 may include a first sensing circuit 1511, a second sensing circuit 1512, and a third sensing circuit 1513.

The first sensing circuit 1511 may provide, to the controller 270, the sensed values of the current value and the voltage value input to the first rectifier 231. The second sensing circuit 1512 may provide, to the controller 270, the sensed values of the current value and the voltage value input to the second rectifier 232. The third sensing circuit 1513 may provide, to the controller 270, the sensed values of the current value and the voltage value input to the third rectifier 241.

The circuits sensing the voltage value, the circuits being included in the first sensing circuit 1511, the second sensing circuit 1512, and the third sensing circuit 1513, may be formed of, for example, a plurality of serially connected resistors, a plurality of parallelly connected diodes, and a plurality of parallelly connected resistors. The circuits sensing the current value, the circuits being included in the first sensing circuit 1511, the second sensing circuit 1512, and the third sensing circuit 1513, may be formed of a shut circuit and a differential amplifier or may include a current transformer component.

The controller 270 may obtain root mean square (RMS) values of the current and the voltage value provided from the first to third sensing circuits 1511 to 1513 and may obtain a first power value by multiplying the obtained current RMS value by the obtained voltage RMS value. The controller 270 may obtain a power value (a second power value) corresponding to corresponding power level information that is pre-stored in the storage 275. The controller 270 may compare the first power value with the second power value. When it is determined that the first power value and the second power value do not correspond to each other, the controller 270 may control an operating frequency of the coil driving circuit 1120 such that the first power value corresponds to the second power value.

For example, when the first power value is greater than the second power value obtained from the storage 275, the controller 270 may reduce the current value input to the rectifying portion 1110 by increasing the operating frequency of the coil driving circuit 1120. When the first power value is less than the second power value obtained from the storage 275, the controller 270 may increase the current value input to the rectifying portion 1110 by decreasing the operating frequency of the coil driving circuit 1120.

The sensing circuit 1510 illustrated in FIG. 15 may be included in the heating devices 100, 1100, and 1300 described above. When the current value input to the rectifying portion 1110 is represented as a current value input to each of the first rectifier 231, the second rectifier 232, and the third rectifier 241, the operating frequency of the coil driving circuit 1120 may be an operating frequency of the first coil driving circuit 251, the second coil driving circuit 252, the third coil driving circuit 261, and the fourth coil driving circuit 266.

FIG. 16 illustrates examples of detailed circuits of the first to third heating coils 1132 to 1134 and the first coil driving circuit 251 and the second coil driving circuit 252 connected to the first to third heating coils 1132 to 1134, included in the heating device 1500 illustrated in FIG. 15.

In FIG. 16, the second coil driving circuit 252 may include a first relay R1 and a second relay R2, on/off of which is controlled by the controller 270. The controller 270 may control an on/off state of the first relay R1 and the second relay R2 according to a power level set in the high-power burner 1131 or a size of a bottom surface of a cooking vessel placed in the high-power burner 1131. Information about the size of the bottom surface of the cooking vessel may be input through the user interface 280 or the communicator 290 or may be sensed by a sensor mounted in the high-power burner 1131. The first relay R1 may be controlled by the controller 270 and may turn on/off connection between current input ends of the second heating coil 1133 and the second coil driving circuit 252. The current input end of the second coil driving circuit 252 may be a point of contact between switches Q1 and Q2. The second relay R2 may be controlled by the controller 270 and may turn on/off connection between current input ends of the third heating coil 1134 and the second coil driving circuit 252.

The controller 270 may control an operating frequency of the first and second coil driving circuits 251 and 252 by controlling an on/off cycle of the switches Q1 and Q2 included in the first and second coil driving circuits 251 and 252. When the on/off cycle of the switches Q1 and Q2 is controlled to be short by the controller 270, the operating frequency of the first and second coil driving circuits 251 and 252 may be increased. When the on/off cycle of the switches Q1 and Q2 is controlled to be long by the controller 270, the operating frequency of the first and second coil driving circuits 251 and 252 may be decreased.

The first and second coil driving circuits 251 and 252 illustrated in FIG. 16 may be supplied to the first coil driving circuit 251 and the second coil driving circuit 252 illustrated in the heating devices 100, 1100, and 1300 described above.

The method according to an embodiment of the disclosure may be realized in the form of a program command which may be executable by various computing devices and may be recorded on a computer-readable recording medium. The computer-readable recording medium may include program commands, data files, data structures, and the like separately or in combinations. The program commands recorded on the computer-readable recording medium may be specially designed and configured for the disclosure or may be well-known to and usable by one of ordinary skill in the field of computer software. Examples of the computer-readable recording medium include magnetic media, such as hard discs, floppy discs, and magnetic tapes, optical media, such as compact disc-read only memories (CD-ROMs) and digital versatile discs (DVDs), magneto-optical media, such as floptical discs, and hardware devices specially configured to store and execute program commands, such as ROMs, RAMs, and flash memories. Examples of the program command include advanced language codes that may be executed by a computer by using an interpreter or the like as well as machine language codes made by a compiler.

One or more embodiments of the disclosure may also be realized in the form of a recording medium including instructions executable by a computer, such as a program module executed by a computer. The computer-readable recording medium may be an arbitrary available medium accessible by a computer and includes all of volatile and non-volatile media and detachable and non-detachable media. Also, the computer-readable recording medium may include both of a computer storage medium and a communication medium. The computer storage recording medium includes all of volatile and non-volatile media and detachable and non-detachable media that are realized by an arbitrary method or technique for storing information, such as computer-readable instructions, data structures, program modules, or other data. The communication medium typically includes computer-readable instructions, data structures, program modules, or other data of modulated data signals, such as carrier waves, or other transmission mechanisms, and includes an arbitrary data transmission mechanism. Also, an embodiment of the disclosure may also be implemented by a computer program or a computer program product including a computer-executable instruction, such as a computer program executable by a computer.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment of the disclosure, the method according to various embodiments disclosed in the present specification may be provided as an inclusion of a computer program product. The computer program product may be, as a product, transacted between a seller and a purchaser. The computer program product may be distributed in the form of a storage medium (for example, a compact disc read-only memory (CD-ROM)), or directly distributed online (e.g., download or upload) through an application store (e.g., Play Store™) or between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

Although the present disclosure has been described with various embodiments, various changes and modifications may be suggested to one skilled in the art. It is intended that the present disclosure encompass such changes and modifications as fall within the scope of the appended claims.

What is claimed is:

1. A heating device comprising:
a high-power burner comprising a first heating coil, a second heating coil, and a third heating coil;
a first alternating current (AC) power source configured to supply first AC power;
a second AC power source configured to supply second AC power having a different phase from the first AC power;
a rectifying portion comprising a first rectifier and a second rectifier, wherein the first rectifier is configured to rectify the first AC power supplied from the first AC power source, and the second rectifier is configured to rectify AC power supplied from the first AC power source or the second AC power source;
a switch configured to selectively connect the first AC power source and the second AC power source to the second rectifier according to a power level of the high-power burner;
a coil driving circuit comprising a first coil driving circuit and a second coil driving circuit, wherein the first coil driving circuit is configured to drive the first heating coil when rectified direct current (DC) power is supplied to the first coil driving circuit from the first rectifier, and the second coil driving circuit is configured to drive at least one of the second heating coil and the third heating coil when rectified DC power is supplied to the second coil driving circuit from the second rectifier; and
a controller configured to control an operation of the switch and an operation of the coil driving circuit according to the power level of the high-power burner.

2. The heating device of claim 1, wherein the controller is further configured to:
control the operation of the switch such that the second AC power source and the second rectifier are connected to each other when the power level of the high-power burner is at a high-power level; and
control the operation of the switch such that the first AC power source and the second rectifier are connected to each other when the power level of the high-power burner is not at the high-power level.

3. The heating device of claim 1, wherein the second coil driving circuit comprises:
a first relay configured to connect the second heating coil to a current input end of the second coil driving circuit in order to selectively supply a first current to the second heating coil; and
a second relay configured to connect the third heating coil to the current input end of the second coil driving circuit in order to selectively supply a second current to the third heating coil, and
the controller is further configured to control an on operation or an off operation of the first relay and the second relay according to the power level of the high-power burner.

4. The heating device of claim 1, wherein the second coil driving circuit comprises:
a first relay configured to connect the second heating coil to a current input end of the second coil driving circuit in order to selectively supply a first current to the second heating coil; and
a second relay configured to connect the third heating coil to the current input end of the second coil driving circuit in order to selectively supply a second current to the third heating coil, and
the controller is further configured to control an on operation or an off operation of the first relay and the second relay according to a size of a bottom surface of a cooking vessel using the high-power burner.

5. The heating device of claim 1, further comprising:
a storage configured to store information in which power level information about the high-power burner and a power value are mapped to each other;
a first sensing circuit configured to sense a first voltage value and a first current value that are input to the first rectifier; and
a second sensing circuit configured to sense a second voltage value and a second current value that are input to the second rectifier,
wherein the controller is further configured to:
obtain a first power value of the high-power burner based on the voltage value and the current value sensed by each of the first sensing circuit and the second sensing circuit;
obtain a second power value of the high-power burner from the storage; and
control an operating frequency of the first coil driving circuit and the second coil driving circuit such that the first power value corresponds to the second power value.

6. The heating device of claim 5, wherein the controller is further configured to:
reduce an amount of the first current input to the first rectifier and the second current input to the second rectifier by increasing the operating frequency of the first coil driving circuit and the second coil driving circuit, in response to determining that the first power value is greater than the second power value; and
increase the amount of the first current input to the first rectifier and the second current input to the second rectifier by decreasing the operating frequency of the first coil driving circuit and the second coil driving circuit, in response to determining that the first power value is less than the second power value.

7. The heating device of claim 1, further comprising a storage configured to store power level information about the high-power burner and a power value corresponding to the power level information,
wherein the controller is further configured to re-set the power value corresponding to the power level information about the high-power burner stored in the storage based on a maximum power value of the high-power burner.

8. The heating device of claim 7, further comprising a user interface configured to:
receive information about the maximum power value of the high-power burner, and
provide the received information about the maximum power value to the controller.

9. The heating device of claim 1, further comprising:
a first sensor configured to sense a temperature of the first rectifier; and
a second sensor configured to sense a temperature of the second rectifier,
wherein the controller is further configured to control the operation of the switch based on the temperatures sensed by the first sensor and the second sensor.

10. The heating device of claim 9, wherein the controller is further configured to control the operation of the switch such that the first AC power is supplied to the second rectifier through the switch, when the temperatures sensed by the first sensor and the second sensor reach predetermined temperatures, when a high-power operation is performed by the high-power burner.

11. The heating device of claim 1, further comprising a first low-power burner comprising a fourth heating coil,
wherein the rectifying portion further comprises a third rectifier configured to rectify the second AC power, regardless of the power level of the high-power burner,
wherein the coil driving circuit further comprises a third coil driving circuit configured to drive the fourth heating coil when rectified DC power is supplied to the third coil driving circuit from the third rectifier, and
wherein the controller is further configured to control an operation of the third coil driving circuit according to a power level of the first low-power burner.

12. The heating device of claim 11, further comprising a second low-power burner comprising a fifth heating coil,
wherein the coil driving circuit further comprises a fourth coil driving circuit configured to drive the fifth heating coil when the rectified DC power is supplied to the fourth coil driving circuit from the third rectifier, and
wherein the controller is further configured to control an operation of the fourth coil driving circuit according to a power level of the second low-power burner.

13. The heating device of claim 12, wherein:
a value of a first current supplied to the first rectifier and the second rectifier is determined according to a value of a first voltage supplied based on the first AC power source and the second AC power source and a first power value of each of the first heating coil, the second heating coil, and the third heating coil, and
a value of a second current supplied to the third rectifier is determined according to a value of a second voltage supplied based on the second AC power source and a second power value of each of the fourth heating coil and the fifth heating coil.

14. The heating device of claim 12, further comprising a user interface configured to:
receive information about a maximum power value of the high-power burner, and
provide the received information about the maximum power value to the controller,
wherein the controller is further configured to re-set a power value corresponding to power level information stored in a storage with respect to the high-power burner, the first low-power burner, and the second low-power burner, based on the maximum power value received through the user interface.

15. The heating device of claim 1, further comprising:
a user interface configured to receive information from a user and provide information to the user; and
a communicator configured to set a communication channel between an external device and the heating device,
wherein the controller is further configured to transmit, to one of the user interface or the external device, notification information notifying a power level change whenever the power level is changed.

16. A heating device comprising:
a power source configured to supply power having different power phases;
a first heating area configured to provide high power or low power;
a second heating area configured to provide low power;
a first rectifying portion including a plurality of rectifiers configured to rectify alternating current (AC) power supplied from the power source and configured to distribute, based on the plurality of rectifiers, a current supplied to the first heating area;
a second rectifying portion configured to rectify AC power of one power phase from among different power phases supplied from the power source and supply, to the second heating area, the rectified power;
a switch configured to selectively connect the power source to the first rectifying portion such that the AC power of the one power phase from among the different power phases supplied from the power source is supplied to the first rectifying portion according to a power level of the heating device; and
a controller configured to control an operation of the switch according to the power level of the heating device.

17. The heating device of claim 16, further comprising a storage configured to store power level information about the first heating area and a power value corresponding to the power level information,
wherein the controller is further configured to re-set the power value corresponding to the power level information about the first heating area stored in the storage based on a maximum power value of the first heating area.

18. The heating device of claim 16, further comprising:
a first sensor configured to sense a temperature of the first rectifying portion; and
a second sensor configured to sense a temperature of the second rectifying portion,
wherein the controller is further configured to control the operation of the switch based on the temperatures sensed by the first sensor and the second sensor.

19. The heating device of claim 18, wherein the controller is further configured to control the operation of the switch such that the first AC power is supplied to the second rectifying portion through the switch, when the temperatures sensed by the first sensor and the second sensor reach predetermined temperatures, when a high-power operation is performed by the first heating area.

20. A power control method of a heating device operating based on different power phases comprises:
receiving a power level setting command of the heating device;
while performing a control operation to selectively supply power of one power phase from among the different power phases to a first rectifying portion of the heating device according to the power level setting command of the heating device, constantly supplying power of another power phase from among the different power phases to the first rectifying portion;
distributing a current by using a plurality of rectifiers included in the first rectifying portion; and
supplying the current distributed by the first rectifying portion to a first heating area, wherein the first heating area provides high power or low power.
